(19) United States
(12) Patent Application Publication
(10) Pub. No.: US 2026/0332212 A1
(43) Pub. Date: Oct. 22, 2026

(54) TECHNIQUES FOR PROCESSING CHANNEL STATE INFORMATION IN FULL DUPLEX COMMUNICATIONS

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Chenxi HAO, Beijing (CN); Qian ZHANG, Basking Ridge, NJ (US); Lei XIAO, San Jose, CA (US); Faris RASSAM, El Cajon, CA (US); Yu ZHANG, San Diego, CA (US)

(21) Appl. No.: 19/106,922

(22) PCT Filed: Nov. 4, 2022
(86) PCT No.: PCT/CN2022/129816

§ 371 Date: Feb. 26, 2025

(51) Int. Cl. H04B 7/06; H04L 5/00

(52) U.S. Cl. CPC H04B 7/0626; H04L 5/0044

(57) ABSTRACT

Methods, systems, and devices for wireless communications are described. A user equipment (UE) to transmit a capability message to a network entity indicating one or more capabilities of the UE related to channel state information (CSI) procedures, such as a CSI processing capability and a CSI timing capability. The UE may receive, from the network entity, a CSI configuration for one or more CSI reference signal (RS) resources in a full duplex slot based on the one or more capabilities. The network entity may transmit one or more CSI-RSs to the UE via the one or more CSI-RS resources of the full duplex slot according to the configuration. The UE may process the one or more CSI-RSs based on a resource configuration of the CSI-RS resources and the one or more capabilities, and may generate and transmit a CSI report to the network entity based on the processing.

### CROSS-REFERENCE TO RELATED APPLICATION

This application is a 371 National Stage of PCT Application No. PCT/CN2022/129816, filed on Nov. 4, 2022, entitled “TECHNIQUES FOR PROCESSING CHANNEL STATE INFORMATION IN FULL DUPLEX COMMUNICATIONS”, and assigned to the assignee hereof. The disclosure of the prior Application is considered part of and is incorporated by reference into this Patent Application.

### FIELD OF TECHNOLOGY

The following relates to wireless communications, including techniques for processing channel state information (CSI) in full duplex communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may perform channel estimation to determine qualities of a channel between the UE and another device, such as a network entity. For example, the network entity may configure the UE with resources for receiving channel state information (CSI) reference signals (CSI-RSs) via a channel, such as a downlink channel. The UE may receive and measure CSI-RS and calculate one or more CSI parameters for the downlink channel. The UE may transmit a CSI report to the network entity indicating the CSI parameter(s) in accordance with a CSI report configuration. In some cases, the network entity may utilize information from the CSI report for performing one or more operations, such as scheduling future communications with the UE.

### SUMMARY

The described techniques relate to improved methods, systems, devices, and apparatuses that support techniques for processing channel state information (CSI) in full duplex communications. For example, the described techniques provide for a user equipment (UE) to transmit a capability message to a network entity indicating one or more capabilities of the UE related to CSI procedures, such as a CSI processing capability and a CSI timing capability. The UE may receive, from the network entity, a CSI configuration for one or more CSI reference signal (RS) resources in a full duplex slot based on the one or more capabilities. The network entity may transmit one or more CSI-RSs to the UE via the one or more CSI-RS resources of the full duplex slot according to the configuration.

In some examples, the full duplex slot may be an example of a subband full duplex (SBFD) slot. The network entity may configure the one or more CSI-RS resources based on the SBFD slot. For example, the network entity may configure a CSI-RS resource that is noncontiguous in a frequency domain of the SBFD slot (e.g., the CSI-RS resource spans one or more downlink subbands of the SBFD slot). Additionally, or alternatively, the network entity may configure a set of CSI-RS resources, where each CSI-RS resource is associated with a respective downlink subband of the SBFD slot. The UE may process the received CSI-RSs using one or more CSI processing units based on the CSI-RS resource configuration. The UE may generate a CSI report based on the processing and may transmit the CI report to the network entity. In some cases, the UE may determine that one or more conditions associated with a latency classification for CSI reporting are satisfied based on the CSI configuration and the one or more capabilities and may transmit the CSI report in accordance with the latency classification.

A method for wireless communications at a UE is described. The method may include transmitting a first message indicating a CSI processing capability of the UE and a CSI timing capability of the UE, receiving a second message indicating a CSI configuration for one or more CSI-RS resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications, receiving, via the one or more CSI-RS resources of the full duplex slot, one or more CSI-RSs based on the CSI configuration, and transmitting a CSI report based on the one or more CSI-RSs in accordance with the CSI processing capability and the CSI timing capability.

An apparatus for wireless communications at a UE is described. The apparatus may include a processor, memory coupled with the processor, and instructions stored in the memory. The instructions may be executable by the processor to cause the apparatus to transmit a first message indicating a CSI processing capability of the UE and a CSI timing capability of the UE, receive a second message indicating a CSI configuration for one or more CSI-RS resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications, receive, via the one or more CSI-RS resources of the full duplex slot, one or more CSI-RSs based on the CSI configuration, and transmit a CSI report based on the one or more CSI-RSs in accordance with the CSI processing capability and the CSI timing capability.

Another apparatus for wireless communications at a UE is described. The apparatus may include means for transmitting a first message indicating a CSI processing capability of the UE and a CSI timing capability of the UE, means for receiving a second message indicating a CSI configuration for one or more CSI-RS resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications, means for receiving, via the one or more CSI-RS resources of the full duplex slot, one or more CSI-RSs based on the CSI configuration, and means for transmitting a CSI report based on the one or more CSI-RSs in accordance with the CSI processing capability and the CSI timing capability.

A non-transitory computer-readable medium storing code for wireless communications at a UE is described. The code may include instructions executable by a processor to transmit a first message indicating a CSI processing capability of the UE and a CSI timing capability of the UE, receive a second message indicating a CSI configuration for one or more CSI-RS resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications, receive, via the one or more CSI-RS resources of the full duplex slot, one or more CSI-RSs based on the CSI configuration, and transmit a CSI report based on the one or more CSI-RSs in accordance with the CSI processing capability and the CSI timing capability.

In some examples of the method, apparatuses, and non-transitory computer-readable medium described herein, jointly processing the one or more CSI-RSs over two downlink subbands of the full duplex slot using a quantity of CSI processing units of the UE in accordance with the CSI processing capability, where the quantity of CSI processing units may be equal to a quantity of the one or more CSI-RS resources, and where the CSI report may be generated based on the processing.

In some examples of the method, apparatuses, and non-transitory computer-readable medium described herein, the one or more CSI-RS resources include a frequency resource that may be noncontiguous in a frequency domain of the full duplex slot and the method, apparatuses, and non-transitory computer-readable medium may include further operations, features, means, or instructions for processing the one or more CSI-RSs using one CSI processing unit based on the frequency resource spanning a downlink subband of the full duplex slot, where the CSI report may be generated based on the processing.

In some examples of the method, apparatuses, and non-transitory computer-readable medium described herein, the one or more CSI-RS resources include a frequency resource that may be noncontiguous in a frequency domain of the full duplex slot and the method, apparatuses, and non-transitory computer-readable medium may include further operations, features, means, or instructions for processing the one or more CSI-RSs using a quantity of CSI processing units in accordance with the CSI processing capability, where the quantity of CSI processing units may be based on a quantity of downlink subbands associated with the frequency resource, and where the CSI report may be generated based on the processing.

In some examples of the method, apparatuses, and non-transitory computer-readable medium described herein, processing the one or more CSI-RSs may include operations, features, means, or instructions for separately processing a first portion of the one or more CSI-RS resources associated with a first downlink subband of the quantity of downlink subbands and a second portion of the one or more CSI-RS resources associated with a second downlink subband of the quantity of downlink subbands.

In some examples of the method, apparatuses, and non-transitory computer-readable medium described herein, the one or more CSI-RS resources include a frequency resource that may be noncontiguous in a frequency domain of the full duplex slot and the method, apparatuses, and non-transitory computer-readable medium may include further operations, features, means, or instructions for processing the one or more CSI-RSs using one CSI processing unit based on a frequency allocation for the frequency resource in the full duplex slot being symmetric over two downlink subbands and based on a size of the frequency allocation satisfying a threshold, where the CSI report may be generated based on the processing.

In some examples of the method, apparatuses, and non-transitory computer-readable medium described herein, the one or more CSI-RS resources include a frequency resource that may be noncontiguous in a frequency domain of the full duplex slot and the method, apparatuses, and non-transitory computer-readable medium may include further operations, features, means, or instructions for processing the one or more CSI-RSs using two or more CSI processing units based on a frequency allocation for the frequency resource in the full duplex slot being asymmetric over two downlink subbands and based on a size of the frequency allocation failing to satisfy a threshold, where the CSI report may be generated based on the processing.

In some examples of the method, apparatuses, and non-transitory computer-readable medium described herein, the one or more CSI-RS resources include a first CSI-RS resource associated with a first downlink subband of the full duplex slot and a second CSI-RS resource associated with a second downlink subband of the full duplex slot and the method, apparatuses, and non-transitory computer-readable medium may include further operations, features, means, or instructions for jointly processing the one or more CSI-RSs using a single CSI processing unit based on a set of parameters associated with the first CSI-RS resource and a set of parameters associated with the second CSI-RS resource being the same, where the CSI report may be generated based on the processing.

In some examples of the method, apparatuses, and non-transitory computer-readable medium described herein, the one or more CSI-RS resources include a first CSI-RS resource associated with a first downlink subband of the full duplex slot and a second CSI-RS resource associated with a second downlink subband of the full duplex slot and the method, apparatuses, and non-transitory computer-readable medium may include further operations, features, means, or instructions for separately processing the one or more CSI-RSs using at least two CSI processing units based on one or more parameters associated with the first CSI-RS resource being different from one or more parameters associated with the second CSI-RS resource, where the CSI report may be generated based on the processing.

In some examples of the method, apparatuses, and non-transitory computer-readable medium described herein, the one or more CSI-RS resources include a frequency resource that may be noncontiguous in a frequency domain of the full duplex slot and the method, apparatuses, and non-transitory computer-readable medium may include further operations, features, means, or instructions for determining that a set of conditions associated with a latency classification for the CSI report may be satisfied, where the latency classification corresponds to a threshold quantity of CSI processing units and processing the one or more CSI-RSs using the threshold quantity of CSI processing units in accordance with the CSI processing capability based on the set of conditions being satisfied, where the CSI report may be transmitted in accordance with a set of parameters associated with the latency classification based on the CSI timing capability.

In some examples of the method, apparatuses, and non-transitory computer-readable medium described herein, the one or more CSI-RS resources may be associated with two or more downlink subbands of the full duplex slot and the method, apparatuses, and non-transitory computer-readable medium may include further operations, features, means, or instructions for determining that a set of conditions associated with a first latency classification for the CSI report may be satisfied, where the first latency classification corresponds to a threshold quantity of CSI processing units and processing the one or more CSI-RSs using a subset of the threshold quantity of CSI processing units in accordance with the CSI processing capability, where the CSI report may be transmitted in accordance with a set of parameters associated with a second latency classification different from the first latency classification based on the one or more CSI-RS resources being allocated to the two or more downlink subbands.

In some examples of the method, apparatuses, and non-transitory computer-readable medium described herein, the one or more CSI-RS resources include a frequency resource that may be noncontiguous in a frequency domain of the full duplex slot and the method, apparatuses, and non-transitory computer-readable medium may include further operations, features, means, or instructions for determining that a set of conditions associated with a latency classification for the CSI report may be satisfied and processing the one or more CSI-RSs using one CSI processing unit based on a size of a frequency domain resource allocation for the frequency resource in the full duplex slot satisfying a threshold, where the CSI report may be transmitted in accordance with a set of parameters associated with the latency classification.

In some examples of the method, apparatuses, and non-transitory computer-readable medium described herein, the one or more CSI-RS resources include a first CSI-RS resource associated with a first downlink subband of the full duplex slot and a second CSI-RS resource associated with a second downlink subband of the full duplex slot and the method, apparatuses, and non-transitory computer-readable medium may include further operations, features, means, or instructions for determining that a set of conditions associated with a latency classification for the CSI report may be satisfied and jointly processing the one or more CSI-RSs using one CSI processing unit based on a first set of parameters associated with the first CSI-RS resource and a second set of parameters associated with the second CSI-RS resource being the same, where the CSI report may be transmitted in accordance with a set of parameters associated with the latency classification.

Some examples of the method, apparatuses, and non-transitory computer-readable medium described herein may further include operations, features, means, or instructions for determining that a set of conditions associated with a latency classification for the CSI report may be satisfied based on the CSI timing capability and processing the one or more CSI-RSs using a quantity of CSI processing units in accordance with the CSI processing capability, where the CSI report may be transmitted in accordance with a set of parameters associated with the latency classification.

In some examples of the method, apparatuses, and non-transitory computer-readable medium described herein, the latency classification may be specific to SBFD slots.

Some examples of the method, apparatuses, and non-transitory computer-readable medium described herein may further include operations, features, means, or instructions for determining that a set of conditions associated with a first latency classification for the CSI report may be satisfied based on the CSI timing capability and processing the one or more CSI-RSs using a quantity of CSI processing units in accordance with the CSI processing capability, where the CSI report may be transmitted in accordance with a set of parameters associated with a second latency classification different from the first latency classification based on the full duplex slot being a SBFD slot.

Some examples of the method, apparatuses, and non-transitory computer-readable medium described herein may further include operations, features, means, or instructions for processing the one or more CSI-RSs in accordance with a quantity of active CSI-RS resources, a quantity of active CSI-RS ports, or a combination thereof, based on the one or more CSI-RS resources including a frequency resource that may be noncontiguous in a frequency domain portion of the full duplex slot, where the CSI report may be generated based on the processing.

In some examples of the method, apparatuses, and non-transitory computer-readable medium described herein, the quantity of active CSI-RS resources may be equal to one and the quantity of active CSI-RS ports may be counted once.

In some examples of the method, apparatuses, and non-transitory computer-readable medium described herein, the quantity of active CSI-RS resources may be equal to two and the quantity of active CSI-RS ports may be counted twice.

A method for wireless communications at a network entity is described. The method may include receiving, from a UE, a first message indicating a CSI processing capability of the UE and a CSI timing capability of the UE, transmitting, to the UE, a second message indicating a CSI configuration for one or more CSI-RS resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications, transmitting, via the one or more CSI-RS resources of the full duplex slot, one or more CSI-RSs based on the CSI configuration, and receiving a CSI report based on the one or more CSI-RSs in accordance with the CSI processing capability and the CSI timing capability.

An apparatus for wireless communications at a network entity is described. The apparatus may include a processor, memory coupled with the processor, and instructions stored in the memory. The instructions may be executable by the processor to cause the apparatus to receive, from a UE, a first message indicating a CSI processing capability of the UE and a CSI timing capability of the UE, transmit, to the UE, a second message indicating a CSI configuration for one or more CSI-RS resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications, transmit, via the one or more CSI-RS resources of the full duplex slot, one or more CSI-RSs based on the CSI configuration, and receive a CSI report based on the one or more CSI-RSs in accordance with the CSI processing capability and the CSI timing capability.

Another apparatus for wireless communications at a network entity is described. The apparatus may include means for receiving, from a UE, a first message indicating a CSI processing capability of the UE and a CSI timing capability of the UE, means for transmitting, to the UE, a second message indicating a CSI configuration for one or more CSI-RS resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications, means for transmitting, via the one or more CSI-RS resources of the full duplex slot, one or more CSI-RSs based on the CSI configuration, and means for receiving a CSI report based on the one or more CSI-RSs in accordance with the CSI processing capability and the CSI timing capability.

A non-transitory computer-readable medium storing code for wireless communications at a network entity is described. The code may include instructions executable by a processor to receive, from a UE, a first message indicating a CSI processing capability of the UE and a CSI timing capability of the UE, transmit, to the UE, a second message indicating a CSI configuration for one or more CSI-RS resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications, transmit, via the one or more CSI-RS resources of the full duplex slot, one or more CSI-RSs based on the CSI configuration, and receive a CSI report based on the one or more CSI-RSs in accordance with the CSI processing capability and the CSI timing capability.

In some examples of the method, apparatuses, and non-transitory computer-readable medium described herein, transmitting the one or more CSI-RSs may include operations, features, means, or instructions for transmitting the one or more CSI-RSs via the first CSI-RS resource and the second CSI-RS resource.

In some examples of the method, apparatuses, and non-transitory computer-readable medium described herein, transmitting the one or more CSI-RSs may include operations, features, means, or instructions for transmitting the one or more CSI-RSs via the frequency resource.

In some examples of the method, apparatuses, and non-transitory computer-readable medium described herein, receiving the CSI report may include operations, features, means, or instructions for receiving the CSI report including an indication that the UE jointly processed the one or more CSI-RSs using a quantity of CSI processing units of the UE in accordance with the CSI processing capability.

In some examples of the method, apparatuses, and non-transitory computer-readable medium described herein, receiving the CSI report may include operations, features, means, or instructions for receiving the CSI report including an indication that the UE separately processed the one or more CSI-RSs using a quantity of CSI processing units of the UE in accordance with the CSI processing capability.

In some examples of the method, apparatuses, and non-transitory computer-readable medium described herein, the one or more CSI-RS resources include a first CSI-RS resource associated with a first downlink subband of the full duplex slot and a second CSI-RS resource associated with a second downlink subband of the full duplex slot and the method, apparatuses, and non-transitory computer-readable medium may include further operations, features, means, or instructions for configuring the first CSI-RS resource in accordance with a first set of parameters and configuring the second CSI-RS resource in accordance with a second set of parameters, where the CSI report includes an indication that the UE jointly processed the one or more CSI-RSs based on the first set of parameters and the second set of parameters being the same.

In some examples of the method, apparatuses, and non-transitory computer-readable medium described herein, the one or more CSI-RS resources include a first CSI-RS resource associated with a first downlink subband of the full duplex slot and a second CSI-RS resource associated with a second downlink subband of the full duplex slot and the method, apparatuses, and non-transitory computer-readable medium may include further operations, features, means, or instructions for configuring the first CSI-RS resource in accordance with a first set of parameters and configuring the second CSI-RS resource in accordance with a second set of parameters, where the CSI report includes an indication that the UE separately processed the one or more CSI-RSs based on the first set of parameters being different from the second set of parameters.

In some examples of the method, apparatuses, and non-transitory computer-readable medium described herein, receiving the CSI report may include operations, features, means, or instructions for receiving the CSI report in accordance with a set of parameters associated with a latency classification for the CSI report based on the CSI timing capability.

In some examples of the method, apparatuses, and non-transitory computer-readable medium described herein, the latency classification may be specific to SBFD slots.

### BRIEF DESCRIPTION OF THE DRAWINGS

FIG. 1 illustrates an example of a wireless communications system that supports techniques for processing channel state information (CSI) in full duplex communications in accordance with one or more aspects of the present disclosure.

FIG. 2 illustrates an example of a wireless communications system that supports techniques for processing CSI in full duplex communications in accordance with one or more aspects of the present disclosure.

FIGS. 3A and 3B illustrate examples of subband full duplex (SBFD) slot formats that support techniques for processing CSI in full duplex communications in accordance with one or more aspects of the present disclosure.

FIG. 4 illustrates an example of a timing diagram that supports techniques for processing CSI in full duplex communications in accordance with one or more aspects of the present disclosure.

FIG. 5 illustrates an example of a process flow that supports techniques for processing CSI in full duplex communications in accordance with one or more aspects of the present disclosure.

FIGS. 6 and 7 illustrate block diagrams of devices that support techniques for processing CSI in full duplex communications in accordance with one or more aspects of the present disclosure.

FIG. 8 illustrates a block diagram of a communications manager that supports techniques for processing CSI in full duplex communications in accordance with one or more aspects of the present disclosure.

FIG. 9 illustrates a diagram of a system including a device that supports techniques for processing CSI in full duplex communications in accordance with one or more aspects of the present disclosure.

FIGS. 10 and 11 illustrate block diagrams of devices that support techniques for processing CSI in full duplex communications in accordance with one or more aspects of the present disclosure.

FIG. 12 illustrates a block diagram of a communications manager that supports techniques for processing CSI in full duplex communications in accordance with one or more aspects of the present disclosure.

FIG. 13 illustrates a diagram of a system including a device that supports techniques for processing CSI in full duplex communications in accordance with one or more aspects of the present disclosure.

FIGS. 14 through 17 illustrate flowcharts showing methods that support techniques for processing CSI in full duplex communications in accordance with one or more aspects of the present disclosure.

### DETAILED DESCRIPTION

In some wireless communications systems, a network entity may transmit reference signals to a user equipment (UE) for the UE to use in channel estimation. For example, a UE may measure channel state information (CSI) reference signals (CSI-RS), synchronization signal blocks (SSBs), or other reference signals received from the network entity to estimate channel quality between the UE and the network entity. The network entity may configure the UE with resources for transmission of the reference signals and the UE may receive the reference signals over the configured resources, perform measurements, and determine channel metrics or parameters associated with the channel quality. The UE may indicate the channel quality to the network entity by, for example, transmitting a CSI report to the network entity, which may use the CSI report information for performing one or more operations, such as scheduling future communications with the UE.

In some aspects, a UE may support full duplex communications with a network entity and may be capable of simultaneously or concurrently transmitting uplink signals and receiving downlink signals. For instance, a full duplex slot may be structured such that downlink communications occur in some frequency subbands and uplink communications occur in other frequency subbands. However, a UE's capability to perform some aspects of a CSI procedure may depend on a resource configuration of associated CSI-RS resources. Conventional CSI configurations may not support full duplex slots, and as such, a UE may not know how to process reference signals received in a full duplex slot.

Techniques described herein relate to CSI procedures for full duplex operations. A network entity may configure CSI-RS resources in a full duplex slot such that the CSI-RS resources align with a full duplex slot configuration. A noncontiguous CSI-RS resource may include or overlap a portion of the full duplex slot that is allocated for uplink communications, but the network entity may only transmit the CSI-RS within the downlink subbands (e.g., and may not transmit the CSI-RS on uplink resources). Additionally, or alternatively, the network entity may configure multiple CSI resources that are constrained within respective downlink subbands. For instance, the network entity may configure a first CSI-RS resource within a first downlink subband and a second CSI-RS resource within a second downlink subband. The network entity may indicate the configured CSI-RS resources to a UE, for example, as part of a CSI report configuration.

The UE may receive the CSI-RS in the full duplex slot in accordance with the configuration and may process the CSI-RS based on one or more UE capabilities. The one or more UE capabilities may be defined based on the full duplex slot (e.g., based on the CSI-RS resource configuration). For example, the UE may determine a quantity of CSI processing units (CPUs) associated with a CSI processing capability of the UE to utilize based on whether the CSI-RS resources are contiguous or noncontiguous, a size of CSI-RS resources allocated to each downlink subband, or the like. In some cases, the UE may determine whether conditions for a latency classification (e.g., high latency, low latency, ultra-low latency) for CSI reporting are satisfied based on the CSI-RS resource configuration and on a CSI timing capability of the UE. The UE may generate the CSI report in accordance with the one or more UE capabilities and may transmit the CSI report to the network entity.

Aspects of the disclosure are initially described in the context of wireless communications systems. Aspects of the disclosure are then discussed with reference to a slot structure, a timing diagram, and a process flow. Aspects of the disclosure are further illustrated by and described with reference to apparatus diagrams, system diagrams, and flowcharts that relate to techniques for processing CSI in full duplex communications.

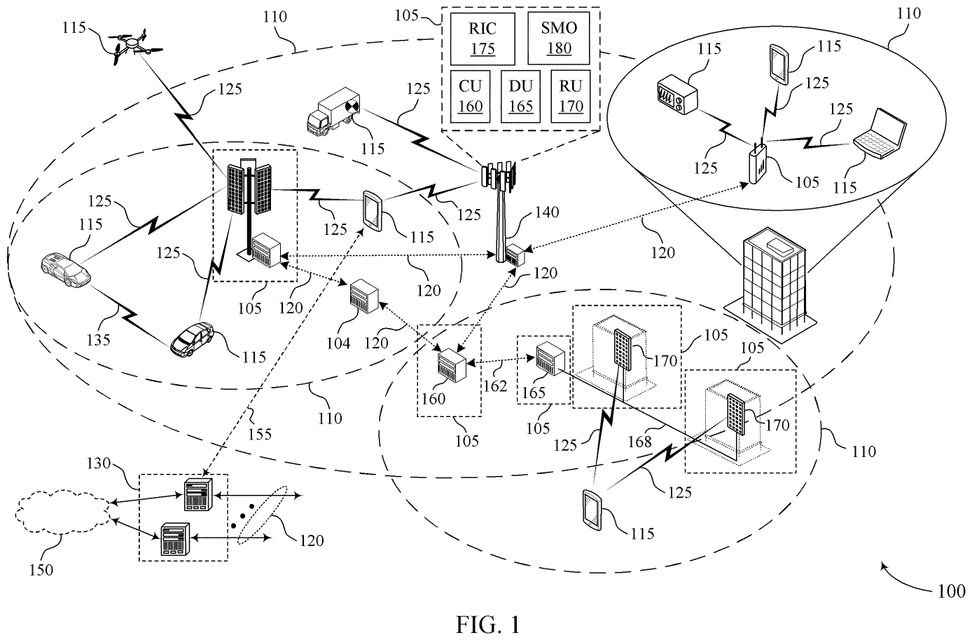

FIG. 1 illustrates an example of a wireless communications system 100 that supports techniques for processing CSI in full duplex communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein. The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for inter-UE coordination-based sidelink communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Af) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In the wireless communications system 100, a UE 115 may measure CSI reference signals (CSI-RS), synchronization signal blocks (SSBs), and other reference signals to estimate channel quality between the UE 115 and another device, such as a network entity 105 or another UE 115. A network entity 105 may configure resources for transmission of the reference signals, such as one or more channel measurement resources (CMRs) and one or more interference measurement resources (IMRs). In some cases, a CSI-RS may include or be an example of a non-zero power (NZP)-CSI-RS or a zero power (ZP)-CSI-RS.

The network entity 105 may indicate the configured resources to the UE 115 via control signaling (e.g., downlink control information (DCI)) and may transmit the reference signals via the configured resources. The UE 115 may receive the reference signals, perform measurements, and estimate the channel by determining channel metrics or parameters (e.g., channel quality indicator, precoding matrix indicator, rank indicator, layer one reference signal received power) associated with the channel quality. The UE 115 may indicate the channel quality to the network entity 105 by, for example, transmitting (e.g., via a physical uplink shared channel (PUSCH)) a CSI report to the network entity 105, which may use the CSI report information for performing one or more operations, such as scheduling future communications with the UE 115.

A UE 115 may be configured (e.g., by a network entity 105) with a CSI report configuration including one or more resource settings that the UE 115 may select and use to generate the CSI report based on channel and interference measurements performed in accordance with the selected resource setting. The CSI report configuration may indicate the configured reference signal resources. In some cases, if a reference signal resource is referred multiple times by one or more resource settings, the reference signal resource may be counted multiple times. Additionally, the CSI report configuration may indicate information that the UE 115 is to include in the CSI report, such as one or more precoding matrix indicators (PMIs), rank indicators (RIs), layer indicators (LIs), channel quality indicators (CQIs), reference signal received power (RSRP) measurements (for example, Layer 1-RSRPs (L1-RSRPs)), signal to interference plus noise (SINR) measurements (for example, L1-SINRs), or the like.

In some implementations, the UE 115 may perform periodic CSI reporting (for example, the network entity 105 may transmit higher layer signaling scheduling periodic CSI reports), aperiodic CSI reporting (for example, the network entity 105 may dynamically configure a CSI report and transmit control signaling to trigger the UE 115 to respond with the CSI report), semi-persistent CSI reporting (for example, the network entity 105 may transmit higher layer signaling scheduling periodic CSI reports and may use dynamic signaling to trigger the periodic CSI reporting), or a combination. The CSI-RS transmissions the UE 115 measures may be periodic CSI-RS transmissions, aperiodic CSI-RS transmissions, semi-persistent CSI-RS transmissions, or a combination.

The CSI report configuration may link to a setting for one or more of an NZP-CSI-RS resource for channel measurement, a CSI-RS resource for interference measurement (CSI-IM), or an NZP CSI-RS resource for interference measurement (NZP IMR), or any combination thereof. In some cases, each resource setting of the one or more resource settings to which the CSI report configuration links may be associated with multiple resource sets, but one active resource set (for example, one active resource set). For example, the CSI report configuration may link to a first NZP CMR set, a second NZP CMR set, and a third NZP CMR set, where the first NZP CMR set may be the active resource set and the second NZP CMR set and third NZP CMR set may be inactive resource sets. Each resource set may include one or more resources (e.g., according to the resource setting), which may be referred to as CSI-RS resources or CSI measurement resources. The UE 115 may utilize one or more resources of the active resource set for receiving a CSI-RS, performing channel estimation, and generating the CSI report. In some cases, the UE 115 may select one resource from the CSI-RS resource set per CSI report, such that each CSI report corresponds to only one CSI-RS resource.

In the case of an NZP-CSI-RS, the UE 115 may measure the received reference signal to determine channel measurements and tracking. A UE 115 that is not receiving a NZP-CSI-RS may instead be configured for a ZP-CSI-RS, which may inform the UE 115 of the resources being used to transmit NZP-CSI-RSs to other UEs 115, thus allowing the UE 115 receiving the ZP-CSI-RS to avoid interference that might arise from NZP-CSI-RSs (by rate-matching around the resources reserved for the ZP-CSI-RS). CSI-RSs may also be configured semi-persistently as semi-persistent (SP) CSI-RSs. These SP-CSI-RSs are activated when a UE 115 receives an activation message (e.g., via a physical downlink shared channel (PDSCH)). The activation message may inform the UE 115 of a resource set on which the SP CSI-RSs (ZP-CSI-RS or NZP-CSI-RS) are to be activated.

The activation message may include an activation status or a deactivation status for each configured CSI-RS resource set. For example, when the activation message indicates to activate a CSI-RS resource set, the UE 115 will operate according to the received CSI-RS configuration (e.g., in the case of a NZP-CSI-RS, the UE 115 may assume that the CSI-RS transmission will occur on the activated set of resources). If the activation message indicates to deactivate the CSI-RS resource set, the UE 115-a will not operate according to the corresponding CSI-RS configuration (e.g., in the case of a NZP-CSI-RS, the UE 115 may assume that the CSI-RS transmission will not occur on the activated set of resources).

In some cases, a UE 115 may have a limited number of CSI processing units (CPUs) for CSI computations involved in processing received CSI-RSs and generating a CSI report. In some cases, a quantity of CPUs of a UE 115 may be equal to a number of simultaneous CSI calculations supported by the UE 115, e.g., per component carrier or across all component carriers. A CSI processing capability of the UE 115 may correspond to the quantity of CPUs of the UE 115. The CPUs may be related to a calculation engine that performs CSI calculations that are reported in the CSI report. A CPU that is actively performing a CSI calculation (e.g., processing a CSI-RS) may be referred to as an occupied or unavailable CPU, while a CPU that is not performing a CSI calculation may be referred to as an unoccupied or available CPU. When generating a CSI report, the UE 115 may allocate one or more available CPUs to perform one or more CSI calculations for the CSI report. For example, the UE 115 may determine a subset of CPUs to utilize for computing the CSI based on a load of the CSI computation, a quantity of CSI-RS resources configured for the CSI-RS, or the like. In some cases, the subset of CSI processing units may remain occupied until the CSI is reported.

A capability of the UE 115 (e.g., a CSI timing capability, a CSI processing capability) may indicate a quantity (e.g., a threshold quantity, such as a maximum quantity) of CSI-RS resources, CSI-RS ports, or both that a UE 115 supports. For example, the UE 115 may support a maximum quantity of reference signal resources (e.g., CSI-RS resources, CSI-RS ports) within a time interval (e.g., a transmission time interval (TTI), such as a slot). In some examples, the UE 115 may support a quantity of reference signal resources (e.g., CSI-RS resources, CSI-RS ports) per component carrier, across all component carriers, per active bandwidth part (BWP), per radio frequency spectrum band, across all radio frequency spectrum bands, or some combination thereof. To generate the CSI report, the UE 115 may be configured to count a quantity (e.g., a maximum quantity) of reference signal resources (e.g., CSI-RS resources, CSI-RS ports, or both) based on the capability. In some cases, a CSI-RS resource may have multiple CSI-RS ports.

In some examples, devices in the wireless communications system 100 may follow a CSI timeline such that when aperiodic CSI reports are triggered by a downlink channel (e.g., a physical downlink control channel (PDCCH)), a UE 115 may have available computational resources, and enough time, to process the received CSI-RSs (e.g., perform one or more computations) and generate the CSI report. For example, once the UE 115 receives a PDCCH with DCI that explicitly triggers a configured CSI-RS resource, the UE 115 may receive and process CSI-RS via the CSI-RS resource. The UE 115 may transmit the generated CSI report in a later slot than the one containing the PDCCH, for example, depending on a configured slot offset. The slot offset for aperiodic CSI reporting may be a semi-statically configured value between 1 and 32 slots, where 1 refers to the next slot after the one in which the DCI trigger is received. In some cases, the slot offset may be configured at a resource set level.

Thus, the CSI timeline may depend on capabilities of the UE 115, such as a CSI timing capability, a CSI processing capability, or a combination thereof, among other examples. Accordingly, some timing requirements for aperiodic CSI reporting may be defined for NR systems.

A first timing requirement (also referred to as a computation delay requirement) may be defined as the minimum number of OFDM symbols, Z, between the last symbol of the PDCCH triggering the aperiodic CSI report and the first symbol of the PUSCH that carries the CSI report. During this time duration, the UE 115 should be able to decode the PDCCH, perform possible CSI-RS/IM measurements (e.g., if the UE 115 does not already have an up-to-date previous channel/interference measurement stored in its memory), perform possible channel estimation, calculate the CSI report, and transmit the CSI report (e.g., via uplink control information (UCI) multiplexing). However, if aperiodic CSI-RS/IM is used with the CSI report, this first requirement alone may not guarantee that the UE 115 has sufficient time to compute the CSI, since the aperiodic CSI-RS could potentially be triggered close (e.g., in time) to the first symbol of the PUSCH transmission. Therefore, a second timing requirement (also referred to as a computation delay requirement) may be defined as the minimum number of OFDM symbols Z′ between the last symbol of the aperiodic CSI-RS/IM used to calculate the CSI report and the first symbol of the PUSCH which carries the CSI report. The Z and Z′ timing requirements may be different in that the Z requirement may encompass DCI decoding time (e.g., a few symbols) while Z′ may not.

With respect to periodic and SPS CSI reporting, a CSI reference resource may be defined as a timing reference for determining an end of a measurement window (e.g., a window in which the UE 115 measures and calculates CSI). In the frequency domain, the CSI reference resource may be defined by a group of downlink physical resource blocks (PRBs) corresponding to a frequency band associated with the calculated CSI. In the time domain, the CSI reference resource reference may be a downlink slot that is defined based on an uplink slot in which the UE 115 is to transmit the CSI report, subcarrier spacing configurations for the downlink and the uplink, and a quantity of the CSI-RS resources that are configured for the UE 115. That is, the CSI reference resource may be understood as the last downlink slot of the CSI measurement window, after which no subsequent channel or interference measurements should be included in the CSI report. In some examples, if SPS or periodic CSI-RS, CSI-IM, or SSBs are used for channel or interference measurements, the UE 115 may not perform channel or interference measurements on the CSI-RS, CSI-IM, or SSB whose last symbol is received up to Z′ symbols before a transmission time of the first symbol of an aperiodic CSI report.

The wireless communications system 100 may support full duplex communications, in which time resources, frequency resources, or both for uplink transmissions may overlap (e.g., partially or fully) with time resources, frequency resources, or both for downlink communications. In some cases, a downlink resource may be separated from an uplink resource in a frequency domain (e.g., by a guard band). A first type of full duplex operation may be referred to as in-band full duplex (IBFD) operation. When supporting IBFD, a UE 115 or a network device 105 may transmit and receive on the same time resources and frequency resources. For instance, downlink and uplink communications may share the same IBFD time or frequency resource (e.g., with full or partial overlapping between the downlink and the uplink). A second type of full duplex operation may be referred to as SBFD, sub-band frequency division duplexing (FDD) operation, or flexible duplex operation. When supporting the second type of full duplex operation, a UE 115 or a network device 105 may transmit and receive at the same time (e.g., on overlapping time resources), but on different frequency resources. In some examples, a full duplex-capable network device (e.g., a network entity 105) may include respective transmission reception points (TRPs) for each direction of communication.

Techniques described herein relate to CSI procedures for full duplex operations. A network entity 105 may configure reference signal resources in a full duplex slot for CSI reporting such that the reference signal resources align with a full duplex slot configuration. For example, the full duplex slot may be structured to include at least a first portion of resources (e.g., time resources, frequency resources) allocated for downlink communications and at least a second portion of resources (e.g., time resources, frequency resources) allocated for uplink communications. The network entity 105 may allocate CSI-RS resources within the first portion of resources corresponding to downlink communications.

In some examples, the network entity 105 may configure noncontiguous CSI-RS resources that span multiple downlink subbands of a full duplex slot. A noncontiguous CSI-RS resource may include or overlap a portion of the full duplex slot that is allocated for uplink communications, but the network entity 105 may only transmit the CSI-RS within the downlink subbands (e.g., and may not transmit the CSI-RS on uplink resources). Additionally, or alternatively, the network entity 105 may configure multiple CSI resources that are constrained within the downlink subbands. For instance, the network entity 105 may configure a first CSI-RS resource within a first downlink subband and a second CSI-RS resource within a second downlink subband.

The network entity 105 may indicate the CSI resource configuration for the full duplex slot as part of the CSI report configuration to inform the UE 115 of resource locations where subsequent CSI-RS is to be received. The UE 115 receiving CSI-RS in the full duplex slot may process CSI and generate a CSI report based on the CSI-RS resource configuration and one or more UE capabilities. The one or more UE capabilities may be defined based on the full duplex slot (e.g., based on the CSI-RS resource configuration). For example, the UE 115 may determine a quantity of CPUs associated with a CSI processing capability of the UE to utilize based on whether the CSI-RS resources are contiguous or noncontiguous, a size of CSI-RS resources allocated to each downlink subband, or the like. In some cases, the UE 115 may determine whether conditions for a latency classification (e.g., high latency, low latency, ultra-low latency) for CSI reporting are satisfied based on the CSI-RS resource configuration and on a CSI timing capability of the UE 115. The UE 115 may generate the CSI report in accordance with the one or more UE capabilities and may transmit the CSI report to the network entity 105. In some cases, the UE 115 may report its capabilities to the network entity 105, and the network entity 105 may use the reported capabilities when configuring the CSI-RS resources.

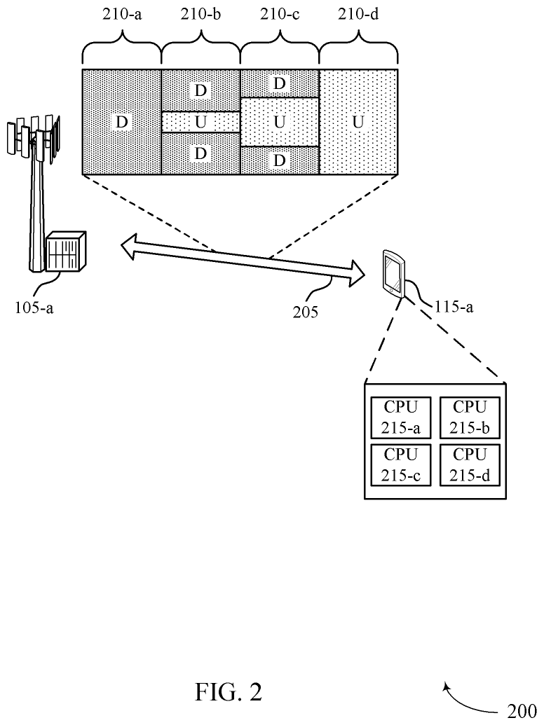

FIG. 2 illustrates an example of a wireless communications system 200 that supports techniques for processing CSI in full duplex communications in accordance with one or more aspects of the present disclosure. In some examples, the wireless communications system 200 may implement aspects of wireless communications system 100. For instance, the wireless communications system 200 may include a network entity 105-a and a UE 115-a, which may be examples of corresponding devices described herein. The network entity 105-a and the UE 115-a may communicate via a communication link 205.

The network entity 105-a and the UE 115-a may each be configured to communicate according to a full duplex communication configuration (e.g., supportive of both downlink communications and uplink communications simultaneously), such as IBFD, SBFD, or the like, among other examples. For example, the communication link 205 may be used for downlink communications, uplink communications, or both. As illustrated, the network entity 105-a and the UE 115-a may communicate transmissions via slots 210, where each slot 210 may be structured to support communications in one or more directions.

The slots 210 may be examples of SBFD slots structured according to an SBFD slot format, where one or more portions of a slot are allocated for uplink transmissions and one or more other portions of the slot are allocated for downlink transmissions. The SBFD slot format may be defined as a ‘D+U’ slot, which may be a slot in which a frequency band (or frequency subband) is used for both uplink and downlink transmissions. The downlink and uplink transmissions may occur in overlapping bands (e.g., IBFD) or adjacent bands (e.g., SBFD). In some examples, downlink and uplink bands in a ‘D+U’ slot may be separated by a frequency guard band, which may reduce interference between the bands. In a given ‘D+U’ slot, a full duplex UE 115 can transmit in an uplink band and/or receive in a downlink band in a same slot. A ‘D+U’ slot may contain only downlink symbols, only uplink symbols, or both (e.g., full duplex symbols). For example, slot 210-a may include only downlink symbols, while slots 210-b and 210-c include uplink and downlink symbols, and slot 210-d may include only uplink symbols. Further, slots 210-b and 210-c may each include two downlink subbands and one uplink subband, though the downlink subbands within slot 210-b may each be wider than the downlink subbands in slot 210-c. Thus, the slots 210-b and 210-c may be considered SBFD slots.

The network entity 105-a may transmit a CSI-RS within one or more CSI-RS resources for measurement by the UE 115-a to estimate channel quality between the network entity 105-a and the UE 115-a (e.g., for one or more channels of the communication link 205, such as PDSCH, PDCCH, PUSCH, PUCCH, etc.). The UE 115-a may measure and process received CSI-RSs using one or more CPUs 215 to generate a CSI report. The UE 115-a may transmit the CSI report to the network entity 105-a indicating channel quality information derived from the CSI-RSs. The CSI report may include one or more PMIs, RIS, LIs, CQIs, RSRP measurements (for example, L1-RSRPs), SINR measurements (for example, L1-SINRs), or the like. The network entity 105-a may use the information indicated by the CSI report to maintain the communication link 205 with the UE 115-a, for scheduling subsequent data transmissions, etc.

The network entity 105-a may configure the UE 115-a with one or more CSI report settings and one or more CSI-RS resources for the CSI procedure. The UE 115-a may receive a control message indicating the CSI report configuration corresponding to one or more resources (for example, CSI measurement resources) over which the UE 115-a may monitor for one or more reference signals (e.g., CSI-RS). For example, the UE 115-a may receive the control message, such as RRC signaling, MAC-CE signaling, DCI signaling, or the like, including the CSI report configuration (which may be equivalently referred to as a “CSI report config”) that may link to one or more resource settings associated with different measurement types, resource sets, etc. In some cases, the UE 115-a may additionally receive an activation message to activate or deactivate one or more of the configured resources or resource sets.

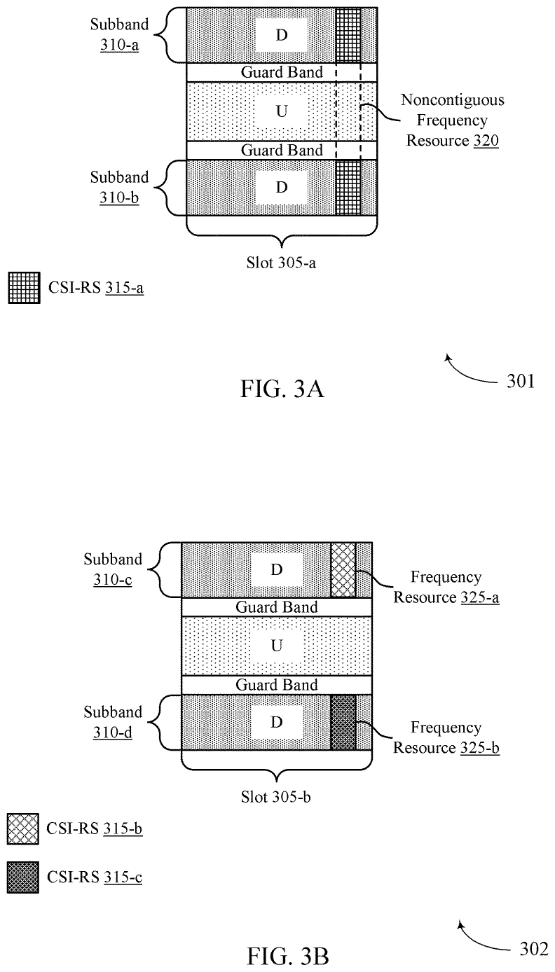

When the UE 115-a and the network entity 105-a support full duplex communications, the network entity 105-a may configure the CSI-RS resources for CSI reporting such that the CSI-RS resources align with a full duplex slot structure. As described with reference to FIG. 3, the network entity 105-a may configure a CSI-RS resource to be noncontiguous in the frequency domain of a full duplex slot. A noncontiguous CSI-RS resource may span one or more downlink subbands and one or more uplink subbands of the full duplex slot, but the CSI-RS may only be transmitted in the downlink portions (e.g., downlink subbands) of the full duplex slot. For example, in slot 210-b, a noncontiguous CSI-RS resource may span one or both ‘D’ portions and the ‘U’ portion, but the CSI-RS may only be transmitted in the one or both ‘D’ portions.

Alternatively, the network entity 105-a may configure a CSI-RS resource to be contiguous within a downlink subband of the full duplex slot, where the CSI-RS resource does not span any uplink portions of the full duplex slot. In such cases, the network entity 105-a may configure multiple CSI-RS resources for the full duplex slot. For example, the network entity 105-a may configure a respective CSI-RS resource for each downlink subband. In the example of slot 210-b, the network entity 105-a may configure a first CSI-RS resource for the first ‘D’ portion (e.g., for a first downlink subband) and a second CSI-RS resource for the second ‘D’ portion (e.g., for a first downlink subband).

Configuration of the CSI procedure at the network entity 105-a and CSI processing (e.g., CSI-RS measurement, CSI calculation) criteria at the UE 115-a may depend on how many CSI resources and, in some cases, CSI ports are associated with (e.g., configured for) a corresponding CSI report. Accordingly, CSI resources in a full duplex slot may be counted (e.g., by the UE 115-a, the network entity 105-a, or both) according to a rule based on the CSI-RS resource configuration. In a first example, the rule may indicate that noncontiguous CSI-RS resources are counted as one active resource, and that corresponding CSI-RS ports are counted once. That is, a noncontiguous CSI-RS resource may be considered as one CSI resource regardless of how many downlink subbands it spans. In contrast, in a second example, the rule may indicate that noncontiguous CSI-RS resources are counted as more than one resource (e.g., based on a quantity of associated downlink subbands) and the corresponding CSI-RS ports are counted multiple times. As a specific example, a noncontiguous CSI-RS resource with four CSI-RS ports that spans two downlink subbands may be counted as two active resources, and the corresponding CSI-RS ports may be counted twice (e.g., for a total of eight CSI-RS ports).

The UE 115-a may transmit, to the network entity 105-a, a capability message indicating one or more capabilities associated with CSI reporting (e.g., in full duplex slots). The network entity 105-a may configure the CSI report and the CSI resources (e.g., CSI-RS resources) for a full duplex slot (e.g., the slot 210-b) based on the one or more capabilities and based on counting the CSI resources in the full duplex slot.

For example, the UE 115-a may support a threshold quantity (e.g., a maximum quantity) of configured CSI resources (e.g., CSI-RS resources, CSI-RS ports, or a combination thereof) for CSI-RS and CSI-IM reception for CSI feedback (i.e., CSI reporting). For example, the UE 115-a may have a capability for supporting a maximum quantity of configured NZP-CSI-RS resources per component carrier, a capability for supporting a maximum quantity of ports across all configured NZP-CSI-RS resources per component carrier, a capability for supporting a maximum quantity of CSI-IM resources per component carrier, or a combination thereof, among other examples. Additionally, or alternatively, the UE 115-a may have one or more capabilities associated with supporting a threshold quantity of active CSI resources (e.g., a threshold quantity of CSI resources that are simultaneously active). Here, the UE 115-a may have a capability for supporting a maximum quantity of simultaneous NZIP-CSI-RS resources in active bandwidth parts across all component carriers, a capability for supporting a maximum quantity of simultaneous NZIP-CSI-RS resources per component carrier, a capability for supporting a maximum total quantity of CSI-RS ports in simultaneous NZP-CSI-RS resources in active bandwidth parts across all component carriers, a capability for supporting a maximum total quantity of CSI-RS ports in simultaneous NZP-CSI-RS resources per component carrier, or a combination thereof.

The UE 115-a may indicate each capability and the corresponding supported quantity of CSI resources to the network entity 105-a in the capability message. For each capability, the UE 115-a may indicate a value from a list of candidate values associated with the capability. For example, for the maximum quantity of configured NZP-CSI-RS resources per component carrier, the UE 115-a may indicate a value from a list of candidate values {1, 2, 3, . . . 32}. The network entity 105-a may determine the quantity of CSI resources to configure for the CSI report in the slot 210-b based on the indicated value(s), where the quantity is determined according to the rule and based on whether the CSI-RS resource is contiguous in the frequency domain of the slot 210-b. For example, if the UE 115-a indicates a maximum quantity of configured NZP-CSI-RS resources per component carrier of 4, and noncontiguous CSI-RS resources are counted twice, the network entity 105-a may configure a maximum of two noncontiguous NZP-CSI-RS resources in the slot 210-b.

Additionally, or alternatively, the UE 115-a may have a CSI processing capability that is defined by a quantity of CPUs 215 with which the UE 115-a is able to perform simultaneous CSI calculations. The UE 115-a may indicate, in the capability message, the CSI processing capability by indicating a quantity of supported simultaneous CSI calculations as Ncpy. Ncpu may be referred to or understood as a threshold (e.g., maximum) quantity of CPUs 215 of the UE 115-e. That is, if the UE 115-a supports Ncpu simultaneous CSI calculations, then the UE 115-a may have NCPU CPUs 215 for processing CSI reports (e.g., across all configured cells). In the example of FIG. 2, the UE 115-a may have four CPUs 215, such that N_{CPU}=4. A CPU 215 that is being used by the UE 115-a for CSI processing may be considered occupied. In general, if L CPUs are occupied for calculation of CSI reports in a given symbol (i.e., if the calculation is performed on symbol by symbol basis), then the UE 115-a may determine that there are N_{CPU}−L unoccupied CPUs. For example, the UE 115-a may utilize a CPU 215-a, a CPU 215-b, and a CPU 215-c, such that L=3 and N_{CPU}−L=1 (e.g., as CPU 215-d is unoccupied). The UE 115-a may process the CSI report using the determined quantity of CPUs 215 and may release the CPUs 215 upon transmitting the CSI report.

Processing a CSI report may occupy a subset of the maximum quantity of CPUs 215 for a quantity of symbols. The quantity of CPUs 215 in the subset may be represented by O_{CPU}. The UE 115-a may determine O_{CPU} as the quantity of CPUs 215 to be utilized for processing the CSI report based on the quantity of CSI-RS resources over which the CSI-RS associated with the CSI report is transmitted. In a first example, O_{CPU} may be equal to the quantity of CSI-RS resources configured in the slot 210-b. Here, the UE 115-a may count the quantity of CSI-RS resources according to the rule, e.g., based on the slot 210-b being an SBFD slot and based on whether a noncontiguous CSI-RS resource is counted as one resource or multiple resources. For instance, if a noncontiguous CSI-RS resource is counted per downlink subband, and the UE 115-a is configured with a CSI-RS resource in the slot 210-b that spans both downlink subbands, the UE 115-a may determine that the quantity of CSI-RS resources is equal to two. Thus, O_{CPU}=2, and the UE 115-a may utilize two CPUs 215 to process the CSI report. In a second example, such as for ultra-low latency CSI reporting, O_{CPU} may be equal to N_{CPU} (e.g., the UE 115-a uses all CPUs 215 for processing the CSI report).

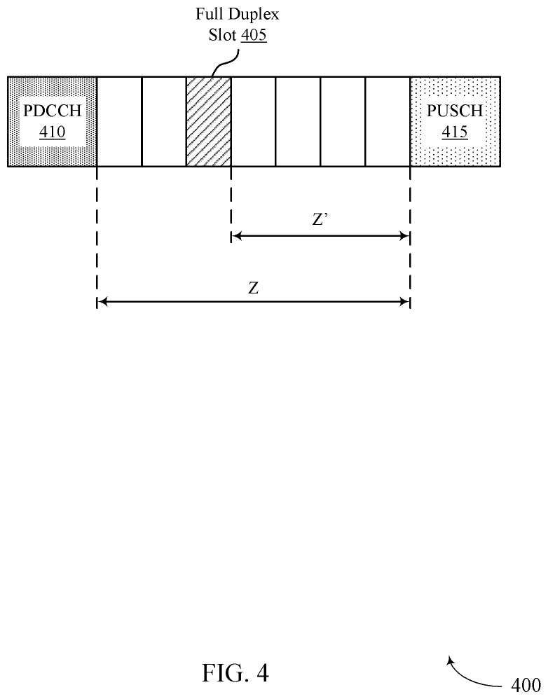

Additionally, and as described with reference to FIG. 4, the UE 115-a may have a timing capability (e.g., a CSI timing capability) corresponding to one or more latency classes for CSI reporting. For example, the UE 115-a may support low latency CSI reporting, ultra-low latency CSI reporting, or high latency reporting. Additionally, in some cases, the UE 115-a may support CSI reporting for beam measurements, which may be associated with a beam reporting latency. Whether each latency class is supported by the UE 115-a for a given CSI report may be determined based on the quantity of CSI-RS resources, the configuration of CSI-RS resources, or both, associated with the CSI report. For example, the UE 115-a may not support low latency or ultra-low latency CSI reporting for full duplex slots.

FIGS. 3A and 3B illustrate examples of CSI-RS resource configurations 301 and 302, respectively, that support techniques for processing CSI in full duplex communications in accordance with one or more aspects of the present disclosure. In some examples, the CSI-RS resource configurations 301 and 302 may implement or be implemented by aspects of wireless communications systems 100 or 200. For instance, a UE (e.g., a UE 115) and a network entity (e.g., a network entity 105), which may be examples of corresponding devices described with reference to FIGS. 1-2, may perform CSI procedures for full duplex (e.g., ‘D+U’) slots structured according to the CSI-RS resource configuration 301 or the CSI-RS resource configuration 302.

In accordance with the techniques described herein, the network entity may configure CSI-RS resources in a full duplex slot based on a format of the full duplex slot, such as the CSI-RS resource configuration 301 or the CSI-RS resource configuration 302. The UE may receive and process CSI-RSs via the CSI-RS resources based on the resource configuration in the full duplex slot. Additionally, as described with reference to FIG. 2, one or more UE capabilities and one or more rules for counting reference signal resources may be defined based on the resource configuration in the full duplex slot.

FIG. 3A illustrates an example of a slot 305-a having the CSI-RS resource configuration 301. The slot 305-a includes a subband 310-a and a subband 310-b, which may include or be examples of downlink frequency bands (e.g., downlink subbands). The network entity may transmit, and the UE may receive, downlink communications, such as a CSI-RS 315-a, in the subband 310-a and the subband 310-b. The slot 305-a also includes a ‘U’ portion allocated for uplink communications. The ‘U’ portion may be separated from the subbands 310 by respective guard bands.

For a CSI procedure, the network entity may configure a CSI-RS resource that is noncontiguous in a frequency domain of the slot 305-a and spans one or more downlink subbands of the slot 305-a, such as a noncontiguous frequency resource 320. The noncontiguous frequency resource 320 spans the subband 310 and the subband 310-b as well as the ‘U’ portion and the guard bands. However, the network entity may only transmit CSI-RS signaling in the portions of the noncontiguous frequency resource 320 that are located within the subband 310-a and the subband 310-b. That is, although the noncontiguous frequency resource 320 is configured to span the ‘U’ portion and the guard bands, the network entity may not transmit any CSI-RS signaling in the ‘U’ portion or the guard bands.

The UE receiving the CSI-RS 315-a via the noncontiguous frequency resource 320 may process the CSI-RS 315-a to generate a CSI report for transmission to the network entity. In some cases, the UE may utilize a quantity of CPUs for processing the CSI-RS 315-a that is equal to the quantity of CSI-RS resources configured for the CSI-RS 315-a. In the example of FIG. 3A, the UE may process the CSI-RS 315-a using one CPU, as the CSI-RS 315-a is transmitted via one resource (e.g., the noncontiguous frequency resource 320).

In other examples, the UE may determine a quantity of CPUs to utilize for processing the CSI-RS 315-a based on the noncontiguous frequency resource 320 being noncontiguous in the frequency domain, based on the noncontiguous frequency resource 320 spanning the subbands 310, or both. Additionally, or alternatively, the UE may determine the quantity of CPUs based on how the noncontiguous frequency resource 320 is to be counted. For example, if a rule for counting CSI-RS resources in SBFD slots indicates that a CSI-RS resource is to be counted as one count regardless of whether the CSI-RS resource is contiguous or noncontiguous, the UE may count the noncontiguous frequency resource 320 once. In another example, the rule may indicate that noncontiguous CSI-RS resources are counted as more than one resource (e.g., based on a quantity of associated downlink subbands) and the corresponding CSI-RS ports are counted multiple times. Here, if the noncontiguous frequency resource 320 is associated with four CSI-RS ports, the UE may count the noncontiguous frequency resource 320 as two resources (e.g., based on the noncontiguous frequency resource 320 spanning two subbands 310), and the corresponding CSI-RS ports may be counted twice (e.g., for a total of eight CSI-RS ports).

If the rule indicates that a noncontiguous frequency resource is to be counted as multiple active resources, the UE may separately process portions of the CSI-RS 315-a received in respective subbands 310. Here, the UE may determine a quantity of CPUs to use based on the quantity of subbands 310 spanned by the noncontiguous frequency resource 320 (e.g., the quantity of CPUs may be equal to the quantity of active resources, which may be equal to the quantity of subbands 310 that the noncontiguous frequency resource 320 spans). The UE may process the portion of the CSI-RS 315-a received in subband 310-a with a first CPU and may process the portion of the CSI-RS 315-a received in subband 310-b with a second CPU.

Alternatively, if the rule indicates that a noncontiguous frequency resource is to be counted as one active resource (e.g., regardless of how many downlink subbands the noncontiguous frequency resource 320 spans), the UE may jointly process the portions of the CSI-RS 315-a received in the respective subbands 310. Jointly processing may refer to the UE utilizing one CPU to process all portions of the CSI-RS 315-a simultaneously. In some cases, whether the UE jointly processes the CSI-RS 315-a may depend on whether a frequency allocation of the noncontiguous frequency resource 320 is symmetric over the subbands 310, a size of the frequency allocation of the noncontiguous frequency resource 320 (e.g., as compared to a bandwidth part associated with the slot 305-a), or both. For example, the UE may jointly process the CSI-RS 315-a if the noncontiguous frequency resource 320 is symmetric over the subbands 310, if the frequency allocation is less than a threshold size (e.g., is less than the bandwidth part), or both. If, however, the noncontiguous frequency resource 320 is not symmetric over the subbands, or if the frequency allocation is greater than the threshold size (e.g., greater than the bandwidth part), the UE may separately process each portion of the noncontiguous frequency resource 320.

Based on the processing of the CSI-RS 315-a, the UE may generate a CSI report and may transmit the CSI report to the network entity in accordance with the CSI processing capability and the CSI timing capability. For example, the UE may transmit the CSI report according to a timing parameter or a latency classification as described with reference to FIG. 4.

FIG. 3B illustrates an example of a slot 305-b having the CSI-RS resource configuration 302. The slot 305-b includes a subband 310-c and a subband 310-d, which may include or be examples of downlink frequency bands (e.g., downlink subbands). The network entity may transmit, and the UE may receive, downlink communications, such as a CSI-RS 315-b and a CSI-RS 315-c, in the subband 310-c and the subband 310-d, respectively.

In the example of FIG. 3B, the network entity may configure a set of CSI-RSs resources, where each CSI-RS resource in the set is contiguous in a respective downlink subband of a frequency domain of the slot 305-b. As illustrated, the network entity may configure a frequency resource 325-a within the subband 310-c and a frequency resource 325-b within the subband 310-d.

The UE receiving the CSI-RSs 315-b and 315-c via the frequency resources 325 may process the CSI-RSs 315-b and 315-c to generate a CSI report for transmission to the network entity. In some cases, the UE may utilize a quantity of CPUs for processing the CSI-RSs 315-b and 315-c that is equal to the quantity of CSI-RS resources configured for the CSI-RSs 315-b and 315-c. In the example of FIG. 3B, the UE may process the CSI-RSs 315-b and 315-c using two CPUs, as the CSI-RSs 315-b and 315-c are transmitted via two resources (e.g., the frequency resources 325). Here, the UE separately processes each CSI-RS 315 received in a respective frequency resource 325.

In other examples, the UE may jointly process the CSI-RSs 315-b and 315-c. Jointly processing may refer to the UE utilizing one CPU to process both CSI-RSs 315-b and 315-c simultaneously. In some cases, whether the UE jointly processes the CSI-RS 315-a may depend on a respective set of parameters (e.g., a scrambling sequence, a scrambling sequence identifier, a power control offset, a periodicity and offset, or the like, among other examples) associated with each frequency resource 325. The network entity may configure the frequency resource 325-a with a first set of parameters and may configure the frequency resource 325-b with a second set of parameters. If the first set of parameters and the second set of parameters are the same, the UE may jointly process the CSI-RSs 315-b and 315-c. That is, the UE may treat the frequency resource 325-a and the frequency resource 325-b as virtually the same frequency resource when the respective sets of parameters are the same. If, however, one or more parameters of the first set of parameters differ from one or more parameters of the second set of parameters, the UE may separately process each CSI-RS 315.

Based on the processing of the CSI-RSs 315, the UE may generate a CSI report and may transmit the CSI report to the network entity in accordance with the CSI processing capability and the CSI timing capability. For example, the UE may transmit the CSI report according to a timing parameter or a latency classification as described with reference to FIG. 4.

FIG. 4 illustrates an example of a timing diagram 400 that supports techniques for processing CSI in full duplex communications in accordance with one or more aspects of the present disclosure. In some examples, the timing diagram 400 may implement or be implemented by aspects of wireless communications systems 100 or 200. For instance, a UE (e.g., a UE 115) and a network entity (e.g., a network entity 105), which may be examples of corresponding devices described with reference to FIGS. 1-2, may perform CSI reporting procedures on a CSI timeline in accordance with the timing diagram 400.

As described herein, the network entity may receive a capability message from the UE indicating a CSI processing capability and a CSI timing capability of the UE. The network entity may determine a CSI report configuration and one or more CSI-RS resources for a CSI procedure in a full duplex slot 405 based on the capability message from the UE and based on a slot format of the full duplex slot 405. For example, as described with reference to FIG. 3A, the network entity may configure a CSI-RS resource that is noncontiguous in a frequency domain of the full duplex slot 405, which may be referred to as a noncontiguous CSI-RS resource. The noncontiguous CSI-RS resource may span one or more downlink subbands of the full duplex slot 405. Additionally, or alternatively, as described with reference to FIG. 3B, the network entity may configure a set of CSI-RS resources corresponding to a set of downlink subbands of the full duplex slot 405, where each CSI-RS resource is contiguous within a downlink subband of the set of downlink subbands.

The network entity may transmit a message (e.g., a control message, such as RRC signaling, MAC-CE, DCI, or the like) indicating the CSI report configuration to the UE via a downlink channel, such as PDCCH 410. In some examples, the PDCCH 410 may trigger the CSI procedure, e.g., for aperiodic CSI reporting. The network entity may transmit one or more CSI-RSs via the one or more CSI-RS resources in the full duplex slot 405. The UE may receive, measure, and process the one or more CSI-RSs, generate a CSI report based on the processing, and transmit the CSI report in accordance with the CSI report configuration via an uplink channel, such as PUSCH 415.

The network entity may configure the CSI report and the CSI-RS resources according to the CSI processing capability and the CSI timing capability of the UE. For example, the CSI timing capability of the UE may correspond to the UE's ability to decode the PDCCH 410, perform the CSI-RS/IM measurements, perform possible channel estimation, calculate the CSI report, and transmit the CSI report via the PUSCH. In some cases, the CSI timing capability may indicate whether the UE supports one or more latency classes for CSI reporting, such as ultra-low latency, low latency, high latency, or beam measurement reporting. Each latency class may be associated with a set of parameters for transmitting CSI reports.

The timing diagram 400 illustrates a first timing requirement (also referred to as a CSI computation delay requirement) Z, which may be defined as the minimum number of symbols between the last symbol of the PDCCH 410 and the first symbol of the PUSCH 415 that carries the CSI report. Additionally, a second timing requirement (also referred to as a CSI computation delay requirement) may be defined as the minimum number of symbols Z′ between the last symbol of the CSI-RS used to calculate the CSI report and the first symbol of the PUSCH 415 which carries the CSI report. The Z and Z′ timing requirements may be different in that the Z requirement may encompass PDCCH 410 decoding time (e.g., a few symbols) while Z′ may not.

Different latency classes may be associated with different sets of values for (Z, Z′). For example, ultra-low latency CSI reporting may be associated with a set of values for (Z₁, Z′₁). This set of values may be referred to as CSI computation delay requirement 1. CSI computation delay requirement 2 values may correspond to low latency CSI reporting, which may be associated with a set of values (Z₁, Z′₁), high latency CSI reporting, which may be associated with a set of values (Z₂, Z′₂), and beam measurement reporting, which may be associated with a set of values (Z₃, Z′₃).

The UE may support a latency class if a corresponding set of conditions is satisfied. Thus, after receiving the PDCCH, the UE may determine whether a set of conditions for a latency class is satisfied, such that the UE may process the CSI-RS and transmit the CSI report according to the values of (Z, Z′) associated with latency class. Additionally, the UE may support a latency class based on the CSI-RS resource configuration in the full duplex slot 405.

For example, if the UE is capable of ultra-low latency CSI reporting, the UE may receive and process the CSI-RS via the full duplex slot 405 and may transmit the CSI report in accordance with one or more values of (Z, Z′) for ultra-low latency. In some cases, the UE may support ultra-low latency CSI reporting even if the CSI-RS is transmitted via a noncontiguous CSI-RS resource, as long as the corresponding set of conditions are satisfied. In other cases, the UE may only support ultra-low latency CSI reporting if the noncontiguous CSI-RS resource spans no more than one downlink subband of the full duplex slot 405, or if the CSI-RS is transmitted via one CSI-RS resource that is constrained within a downlink subband of the full duplex slot 405. That is, even if the set of conditions for ultra-low latency CSI reporting are satisfied, the UE may not transmit the CSI report using the ultra-low latency set of parameters.

In some examples, the UE may support low latency CSI reporting only if the one or more CSI-RS resources are able to be jointly processed. For instance, when the CSI report is linked to one noncontiguous CSI-RS resource that spans two downlink subbands, the UE may support low latency CSI reporting if a frequency allocation of the noncontiguous CSI-RS resource is symmetric across the two downlink subbands and if a size of the frequency allocation satisfies a threshold (e.g., is less than an associated bandwidth part). However, if the frequency allocation is not symmetric across the tow downlink subbands, or if the size of the frequency allocation does not satisfy the threshold (e.g., is greater than the associated bandwidth part), the UE may not transmit the CSI report using the low latency parameter set (e.g., using Z₁, Z′₁). When the CSI report is linked to a set of CSI-RS resources that are contiguous within one or more downlink subbands, the UE may support low latency CSI reporting as long as each CSI-RS resource in the set of CSI-RS resources are configured with the same resource parameters (e.g., enabling the UE to jointly process the set of CSI-RS resources).

Alternatively, the UE may not support ultra-low latency or low latency CSI reporting when the CSI report is associated with a full duplex slot. In such cases, the UE may process and transmit the CSI report according to a set of parameters associated with high latency CSI reporting (e.g., (Z₃, Z′₃)).

In still other examples, the UE may be configured with a set of parameters specific to full duplex communications for each latency class. For example, the UE may be configured with values for (Z₁, Z′₁), (Z₂, Z′₂), and (Z₃, Z′₃) to be used for CSI reporting in full duplex slots, such as SBFD slots.

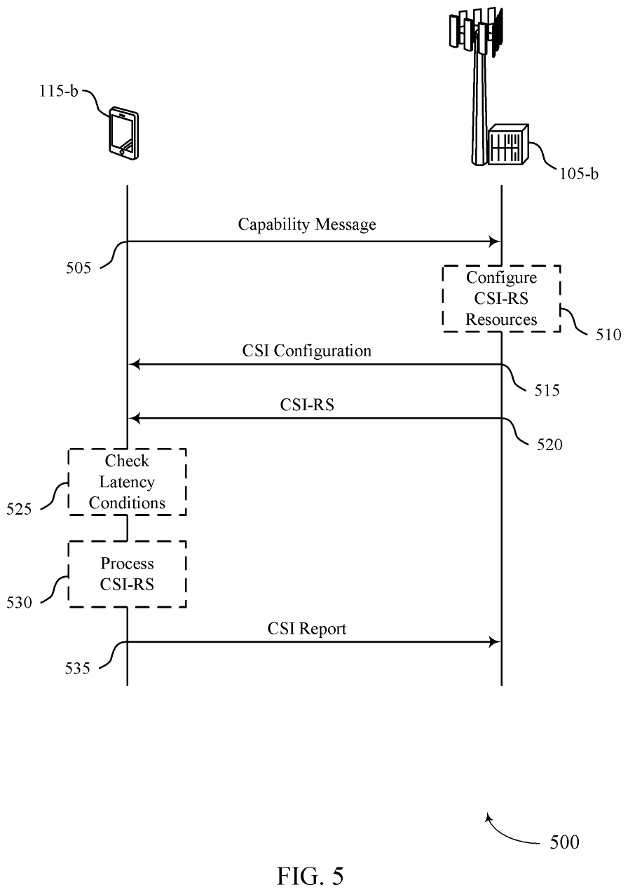

FIG. 5 illustrates an example of a process flow 500 that supports techniques for processing CSI in full duplex communications in accordance with one or more aspects of the present disclosure. The process flow 500 includes a UE 115-b, which may be an example of a UE in accordance with aspects of the present disclosure. The process flow 500 also includes a network entity 105-b, which may be an example of a network entity in accordance with aspects of the present disclosure. The process flow 500 may implement aspects of the wireless communications system 100 or the wireless communications system 200. For instance, the process flow 500 may support CSI procedures in full duplex slots.

In the following description of the process flow 500, the signaling exchanged between the UE 115-b and the network entity 105-b may be exchanged in a different order than the example order shown, or the operations performed by the UE 115-b and the network entity 105-b may be performed in different orders or at different times. Some operations may also be omitted from the process flow 500, and other options may be added to the process flow 500.

At 505, the UE 115-b may transmit, and the network entity 105-b may receive, a capability message indicating a CSI processing capability of the UE 115-b and a CSI timing capability of the UE 115-b.

At 510, the network entity 105-b may configure one or more CSI-RS resources of a full duplex slot, e.g., based on the indicated CSI processing capability and CSI timing capability. In some examples, the network entity 105-b may configure a first CSI-RS resource in a first downlink subband of the full duplex slot and a second CSI-RS resource in a second downlink subband of the full duplex slot. Each CSI-RS resource may be contiguous within the respective downlink subband. Additionally, or alternatively, the network entity 105-b may configure a noncontiguous CSI-RS resource that spans one or more downlink subbands of the full duplex slot and is noncontiguous in a frequency domain of the full duplex slot.

At 515, the network entity 105-b may transmit, and the UE 115-b may receive, a message indicating a CSI configuration for the one or more CSI-RS resources. The CSI configuration may indicate a resource configuration (e.g., a resource allocation) for the one or more CSI-RS resources in the full duplex slot. Additionally, the CSI configuration may indicate one or more other parameters for a CSI report to be transmitted by the UE 115-b.

At 520, the network entity 105-b may transmit, and the UE 115-b may receive, one or more CSI-RSs via the one or more CSI-RS resources based on the CSI configuration. For example, the UE 115-b may receive CSI-RS via a noncontiguous (e.g., in the frequency domain) CSI-RS resource that spans one or more downlink subbands of the full duplex slot. Additionally, or alternatively, the UE 115-b may receive CSI-RS via a set of contiguous CSI-RS resources, such as a first CSI-RS resource that is contiguous (e.g., in the frequency domain) within a first downlink subband of the full duplex slot and a second CSI-RS resource that is contiguous (e.g., in the frequency domain) within a second downlink subband of the full duplex slot.

At 525, the UE 115-b may check whether a set of conditions associated with a latency classification for the CSI report are satisfied. In some cases, the latency classification may be specific to SBFD slots.

In some examples, the UE 115-b may determine whether a set of conditions for low latency CSI reporting are satisfied based on the CSI configuration and the CSI-RS resources. In some examples, the UE 115-b may determine that the set of conditions are satisfied based on a capability of the UE 115-b (e.g., the CSI timing capability) for supporting low latency CSI reporting.

In some cases, the UE 115-b may determine whether a set of conditions for ultra-low latency CSI reporting are satisfied based on the CSI configuration and the CSI-RS resources. In some examples, the UE 115-b may determine that the set of conditions are satisfied based on a capability of the UE 115-b (e.g., the CSI timing capability) for supporting ultra-low latency CSI reporting. In some cases, ultra-low latency CSI reporting may be associated with a threshold quantity of CPUs to be used for processing the CSI report. The threshold quantity of CPUs may correspond to a maximum quantity of CPUs supported by the UE 115-b.

The set of conditions for ultra-low latency CSI reporting may include, for example, whether the CSI report is an aperiodic CSI report (e.g., triggered by the network entity 105-b), whether the UE 115-b is configured with a codebook type corresponding to ultra-low latency transmissions, whether the CSI report is for wideband CSI, and whether the CSI report is to be transmitted without a corresponding PUSCH (e.g., data) transmission, without HARQ-ACK feedback, or both. In some cases, the set of conditions may further include a threshold quantity of available CPUs at the UE 115-b, a maximum quantity of CSI-RS ports associated with a maximum quantity of CSI-RS resources.

The set of conditions for ultra-low latency CSI reporting may be satisfied if the CSI report is an aperiodic CSI report for wideband CSI that is triggered without a corresponding PUSCH transmission or HARQ-ACK transmission (or both), if the UE 115-b has the threshold quantity of available CPUs when the CSI report is triggered, if the UE 115-b is configured with the codebook type corresponding to ultra-low latency transmissions, and if the CSI configuration indicates a maximum of 4 CSI-RS ports for one CSI-RS resource.

At 530, the UE 115-b may process the one or more CSI-RSs in accordance with the CSI processing capability. In some cases, the UE 115-b may process the one or more CSI-RSs using a quantity of CPUs, based on a quantity of the CSI-RS resources, or a combination thereof. For example, the UE 115-b may jointly process the one or more CSI-RSs over two downlink subbands of the full duplex slot using a quantity of CPUs that is equal to the quantity of CSI-RS resources. The UE 115-b may count the quantity of CSI-RS resources according to a rule as described with reference to FIG. 24. For example, the UE 115-b may count a quantity of active CSI-RS resources, a quantity of active CSI-RS ports, or a combination thereof of the CSI-RS resources based on the one or more CSI-RS resources including a frequency resource that is noncontiguous in a frequency domain of the full duplex slot, and the UE 115-b may process the CSI-RSs in accordance with the quantity of active CSI-RS resources, the quantity of active CSI-RS ports, or both.

In some examples, such as when the CSI-RS resources include a CSI-RS resource that is noncontiguous in the frequency domain of the full duplex slot, the UE 115-b may process the one or more CSI-RSs using one CPU based on the frequency resource spanning a downlink subband of the full duplex slot. In other examples, if the noncontiguous CSI-RS resource spans two or more downlink subbands, the UE 115-b may process the CSI-RSs using two or more CPUs (e.g., the quantity of CPUs may correspond to the quantity of downlink subbands spanned by the noncontiguous CSI-RS resource). Here, the UE 115-b may separately process each portion of the CSI-RSs associated with a downlink subband using a respective CPU.

In some cases, the UE 115-b may determine the quantity of CPUs based on whether a frequency allocation of the CSI-RS resources is symmetric over two (or more) downlink subbands, and based on a size of the frequency allocation in each downlink subband. For example, for a noncontiguous CSI-RS resource spanning two downlink subbands, if the frequency allocation is asymmetric over the two downlink subbands, or if the size of the frequency allocation fails to satisfy a threshold (such as less than half of an associated bandwidth part), the UE 115-b may separately process each portion of the CSI-RSs corresponding to a downlink subband using a respective CPU. Alternatively, if the frequency allocation is symmetric over the two downlink subbands, and if the size of the frequency allocation satisfies the threshold, the UE 115-b may jointly process the CSI-RSs using one CPU.

In some examples, such as when the CSI-RS resources include a set of CSI-RS resources, each CSI-RS resource contiguous within a respective downlink subband, the UE 115-b may determine the quantity of CPUs based on a set of parameters associated with each CSI-RS resource. For example, if two of the CSI-RS resources have the same values for the set of parameters, the UE 115-b may jointly process the two CSI-RS resources using a same CPU. Alternatively, if the two CSI-RS resources have different values for one or more parameters of the set of parameters (e.g., exclude frequency domain resource allocations), the UE 115-b may process the CSI-RSs separately, using respective CPUs.

In some cases, the UE 115-b may determine the quantity of CPUs based on whether a set of conditions associated with a latency classification were satisfied at 525. For example, if the UE 115-b determined that the set of conditions for ultra-low latency reporting were satisfied, the UE 115-b may process the one or more CSI-RSs using the maximum quantity of CPUs in accordance with the CSI processing capability.

In other examples, the UE 115-b may or may not support ultra-low latency CSI reporting based on the CSI-RS resource configuration. For example, the UE 115-b may support ultra-low latency CSI reporting if the CSI-RS resource is one noncontiguous CSI-RS resource that spans no more than one downlink subband of the UE 115-b. In such examples, the UE 115-b may process the CSI-RS using the maximum quantity of CPUs. Alternatively, if the CSI-RS resource is a noncontiguous CSI-RS resource that spans multiple downlink subbands, or if the CSI-RS resource is a set of CSI-RS resources associated with respective downlink subbands, the UE 115-b may not support ultra-low latency CSI reporting (e.g., even if the set of conditions for ultra-low latency CSI reporting are satisfied) and may utilize a subset of CPUs for processing the CSI-RSs.

In other examples, the UE 115-b may not support ultra-low latency CSI reporting or low latency CSI reporting in SBFD slots even if the corresponding set of conditions is satisfied. In such cases, the UE 115-b may process the one or more CSI-RSs using a subset of CPUs of the maximum quantity of CPUs in accordance with the CSI processing capability.

At 535, the UE 115-b may transmit, and the network entity 105-b may receive, the CSI report based on the processing and in accordance with the CSI timing capability.

If the UE 115-b processed the one or more CSI-RSs based on ultra-low latency CSI reporting conditions (e.g., using the maximum quantity of CPUs), the UE 115-b may transmit the CSI report in accordance with a set of parameters associated with ultra-low latency CSI reporting. For example, the UE 115-b may transmit the CSI report according to CSI computation delay requirements (Z₁, Z′₁) for ultra-low latency CSI reporting and based on the CSI timing capability.

If the UE 115-b does not support ultra-low latency CSI reporting and instead processed the one or more CSI-RSs based on low latency CSI reporting conditions (e.g., using a subset of the maximum quantity of CPUs), the UE 115-b may transmit the CSI report in accordance with a set of parameters associated with low latency CSI reporting and based on the CSI timing capability. For example, the UE 115-b may transmit the CSI report according to CSI computation delay requirements (Z₁, Z′₁) for low latency CSI reporting and based on the CSI timing capability.

If the UE 115-b does not support ultra-low latency CSI reporting or low latency reporting, the UE 115-b may transmit the CSI report in accordance with a set of parameters associated with high latency CSI reporting and based on the CSI timing capability. For example, the UE 115-b may transmit the CSI report according to CSI computation delay requirements (Z₂, Z′₂) for low latency CSI reporting and based on the CSI timing capability.

In other examples, the UE 115-b may transmit the CSI report in accordance with a CSI computation delay requirement table that is specific to SBFD slot CSI procedures.

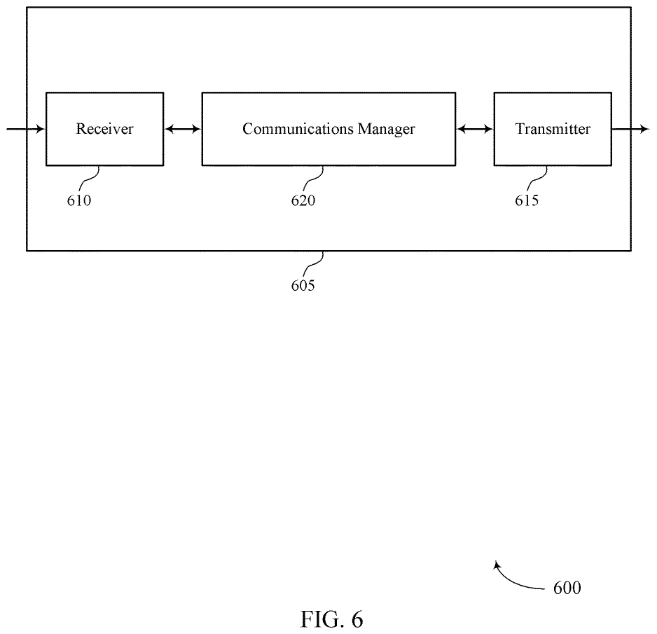

FIG. 6 illustrates a block diagram 600 of a device 605 that supports techniques for processing CSI in full duplex communications in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for processing CSI in full duplex communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for processing CSI in full duplex communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for processing CSI in full duplex communications as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for transmitting a first message indicating a CSI processing capability of the UE and a CSI timing capability of the UE. The communications manager 620 may be configured as or otherwise support a means for receiving a second message indicating a CSI configuration for one or more CSI reference signal resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications. The communications manager 620 may be configured as or otherwise support a means for receiving, via the one or more CSI reference signal resources of the full duplex slot, one or more CSI reference signals based on the CSI configuration. The communications manager 620 may be configured as or otherwise support a means for transmitting a CSI report based on the one or more CSI reference signals in accordance with the CSI processing capability and the CSI timing capability.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more efficient utilization of communication resources. In particular, using the techniques described herein, the device 605 may perform CSI measurement and reporting when communicating according to full duplex communications. As a result, the device 605 may be able to maximize the use of allocated resources or more efficiently utilize communication resources (e.g., by simultaneously transmitting and receiving using the communication resources).

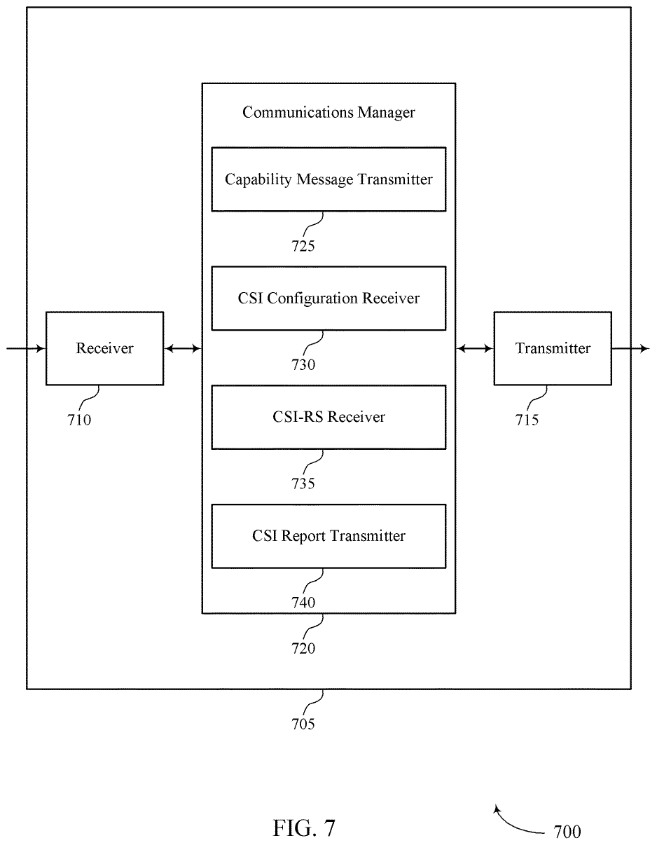

FIG. 7 illustrates a block diagram 700 of a device 705 that supports techniques for processing CSI in full duplex communications in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for processing CSI in full duplex communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for processing CSI in full duplex communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for processing CSI in full duplex communications as described herein. For example, the communications manager 720 may include a capability message transmitter 725, a CSI configuration receiver 730, a CSI-RS receiver 735, a CSI report transmitter 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The capability message transmitter 725 may be configured as or otherwise support a means for transmitting a first message indicating a CSI processing capability of the UE and a CSI timing capability of the UE. The CSI configuration receiver 730 may be configured as or otherwise support a means for receiving a second message indicating a CSI configuration for one or more CSI reference signal resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications. The CSI-RS receiver 735 may be configured as or otherwise support a means for receiving, via the one or more CSI reference signal resources of the full duplex slot, one or more CSI reference signals based on the CSI configuration. The CSI report transmitter 740 may be configured as or otherwise support a means for transmitting a CSI report based on the one or more CSI reference signals in accordance with the CSI processing capability and the CSI timing capability.

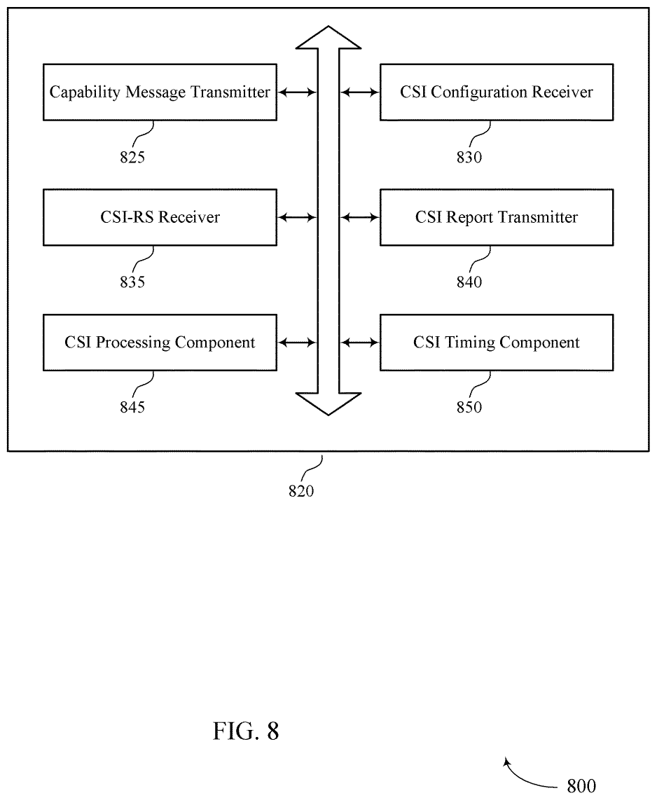

FIG. 8 illustrates a block diagram 800 of a communications manager 820 that supports techniques for processing CSI in full duplex communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for processing CSI in full duplex communications as described herein. For example, the communications manager 820 may include a capability message transmitter 825, a CSI configuration receiver 830, a CSI-RS receiver 835, a CSI report transmitter 840, a CSI processing component 845, a CSI timing component 850, or any combination thereof. Each of these components may communicate, directly or indirectly, with one another (e.g., via one or more buses).

The communications manager 820 may support wireless communications at a UE in accordance with examples as disclosed herein. The capability message transmitter 825 may be configured as or otherwise support a means for transmitting a first message indicating a CSI processing capability of the UE and a CSI timing capability of the UE. The CSI configuration receiver 830 may be configured as or otherwise support a means for receiving a second message indicating a CSI configuration for one or more CSI reference signal resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications. The CSI-RS receiver 835 may be configured as or otherwise support a means for receiving, via the one or more CSI reference signal resources of the full duplex slot, one or more CSI reference signals based on the CSI configuration. The CSI report transmitter 840 may be configured as or otherwise support a means for transmitting a CSI report based on the one or more CSI reference signals in accordance with the CSI processing capability and the CSI timing capability.

In some examples, the CSI processing component 845 may be configured as or otherwise support a means for jointly processing the one or more CSI reference signals over two downlink subbands of the full duplex slot using a quantity of CSI processing units of the UE in accordance with the CSI processing capability, where the quantity of CSI processing units is equal to a quantity of the one or more CSI reference signal resources, and where the CSI report is generated based on the processing.

In some examples, the one or more CSI reference signal resources include a frequency resource that is noncontiguous in a frequency domain of the full duplex slot, and the CSI processing component 845 may be configured as or otherwise support a means for processing the one or more CSI reference signals using one CSI processing unit based on the frequency resource spanning a downlink subband of the full duplex slot, where the CSI report is generated based on the processing.

In some examples, the one or more CSI reference signal resources include a frequency resource that is noncontiguous in a frequency domain of the full duplex slot, and the CSI processing component 845 may be configured as or otherwise support a means for processing the one or more CSI reference signals using a quantity of CSI processing units in accordance with the CSI processing capability, where the quantity of CSI processing units is based on a quantity of downlink subbands associated with the frequency resource, and where the CSI report is generated based on the processing.

In some examples, to support processing the one or more CSI reference signals, the CSI processing component 845 may be configured as or otherwise support a means for separately processing a first portion of the one or more CSI reference signal resources associated with a first downlink subband of the quantity of downlink subbands and a second portion of the one or more CSI reference signal resources associated with a second downlink subband of the quantity of downlink subbands.

In some examples, the one or more CSI reference signal resources include a frequency resource that is noncontiguous in a frequency domain of the full duplex slot, and the CSI processing component 845 may be configured as or otherwise support a means for processing the one or more CSI reference signals using one CSI processing unit based on a frequency allocation for the frequency resource in the full duplex slot being symmetric over two downlink subbands and based on a size of the frequency allocation satisfying a threshold, where the CSI report is generated based on the processing.

In some examples, the one or more CSI reference signal resources include a frequency resource that is noncontiguous in a frequency domain of the full duplex slot, and the CSI processing component 845 may be configured as or otherwise support a means for processing the one or more CSI reference signals using two or more CSI processing units based on a frequency allocation for the frequency resource in the full duplex slot being asymmetric over two downlink subbands and based on a size of the frequency allocation failing to satisfy a threshold, where the CSI report is generated based on the processing.

In some examples, the one or more CSI reference signal resources include a first CSI reference signal resource associated with a first downlink subband of the full duplex slot and a second CSI reference signal resource associated with a second downlink subband of the full duplex slot, and the CSI processing component 845 may be configured as or otherwise support a means for jointly processing the one or more CSI reference signals using a single CSI processing unit based on a set of parameters associated with the first CSI reference signal resource and a set of parameters associated with the second CSI reference signal resource being the same, where the CSI report is generated based on the processing.

In some examples, the one or more CSI reference signal resources include a first CSI reference signal resource associated with a first downlink subband of the full duplex slot and a second CSI reference signal resource associated with a second downlink subband of the full duplex slot, and the CSI processing component 845 may be configured as or otherwise support a means for separately processing the one or more CSI reference signals using at least two CSI processing units based on one or more parameters associated with the first CSI reference signal resource being different from one or more parameters associated with the second CSI reference signal resource, where the CSI report is generated based on the processing.

In some examples, the one or more CSI reference signal resources include a frequency resource that is noncontiguous in a frequency domain of the full duplex slot, and the CSI timing component 850 may be configured as or otherwise support a means for determining that a set of conditions associated with a latency classification for the CSI report are satisfied, where the latency classification corresponds to a threshold quantity of CSI processing units. In some examples, the one or more CSI reference signal resources include a frequency resource that is noncontiguous in a frequency domain of the full duplex slot, and the CSI processing component 845 may be configured as or otherwise support a means for processing the one or more CSI reference signals using the threshold quantity of CSI processing units in accordance with the CSI processing capability based on the set of conditions being satisfied, where the CSI report is transmitted in accordance with a set of parameters associated with the latency classification based on the CSI timing capability.

In some examples, the one or more CSI reference signal resources are associated with two or more downlink subbands of the full duplex slot, and the CSI timing component 850 may be configured as or otherwise support a means for determining that a set of conditions associated with a first latency classification for the CSI report are satisfied, where the first latency classification corresponds to a threshold quantity of CSI processing units. In some examples, the one or more CSI reference signal resources are associated with two or more downlink subbands of the full duplex slot, and the CSI processing component 845 may be configured as or otherwise support a means for processing the one or more CSI reference signals using a subset of the threshold quantity of CSI processing units in accordance with the CSI processing capability, where the CSI report is transmitted in accordance with a set of parameters associated with a second latency classification different from the first latency classification based on the one or more CSI reference signal resources being allocated to the two or more downlink subbands.

In some examples, the one or more CSI reference signal resources include a frequency resource that is noncontiguous in a frequency domain of the full duplex slot, and the CSI timing component 850 may be configured as or otherwise support a means for determining that a set of conditions associated with a latency classification for the CSI report are satisfied. In some examples, the one or more CSI reference signal resources include a frequency resource that is noncontiguous in a frequency domain of the full duplex slot, and the CSI processing component 845 may be configured as or otherwise support a means for processing the one or more CSI reference signals using one CSI processing unit based on a size of a frequency domain resource allocation for the frequency resource in the full duplex slot satisfying a threshold, where the CSI report is transmitted in accordance with a set of parameters associated with the latency classification.

In some examples, the one or more CSI reference signal resources include a first CSI reference signal resource associated with a first downlink subband of the full duplex slot and a second CSI reference signal resource associated with a second downlink subband of the full duplex slot, and the CSI timing component 850 may be configured as or otherwise support a means for determining that a set of conditions associated with a latency classification for the CSI report are satisfied. In some examples, the one or more CSI reference signal resources include a first CSI reference signal resource associated with a first downlink subband of the full duplex slot and a second CSI reference signal resource associated with a second downlink subband of the full duplex slot, and the CSI processing component 845 may be configured as or otherwise support a means for jointly processing the one or more CSI reference signals using one CSI processing unit based on a first set of parameters associated with the first CSI reference signal resource and a second set of parameters associated with the second CSI reference signal resource being the same, where the CSI report is transmitted in accordance with a set of parameters associated with the latency classification.

In some examples, the CSI timing component 850 may be configured as or otherwise support a means for determining that a set of conditions associated with a latency classification for the CSI report are satisfied based on the CSI timing capability. In some examples, the CSI processing component 845 may be configured as or otherwise support a means for processing the one or more CSI reference signals using a quantity of CSI processing units in accordance with the CSI processing capability, where the CSI report is transmitted in accordance with a set of parameters associated with the latency classification.

In some examples, the latency classification is specific to subband full duplex slots.

In some examples, the CSI timing component 850 may be configured as or otherwise support a means for determining that a set of conditions associated with a first latency classification for the CSI report are satisfied based on the CSI timing capability. In some examples, the CSI processing component 845 may be configured as or otherwise support a means for processing the one or more CSI reference signals using a quantity of CSI processing units in accordance with the CSI processing capability, where the CSI report is transmitted in accordance with a set of parameters associated with a second latency classification different from the first latency classification based on the full duplex slot being a subband full duplex slot.

In some examples, the CSI processing component 845 may be configured as or otherwise support a means for processing the one or more CSI reference signals in accordance with a quantity of active CSI reference signal resources, a quantity of active CSI reference signal ports, or a combination thereof, based on the one or more CSI reference signal resources including a frequency resource that is noncontiguous in a frequency domain portion of the full duplex slot, where the CSI report is generated based on the processing.

In some examples, the quantity of active CSI reference signal resources is equal to one. In some examples, the quantity of active CSI reference signal ports are counted once.

In some examples, the quantity of active CSI reference signal resources is equal to two. In some examples, the quantity of active CSI reference signal ports are counted twice.

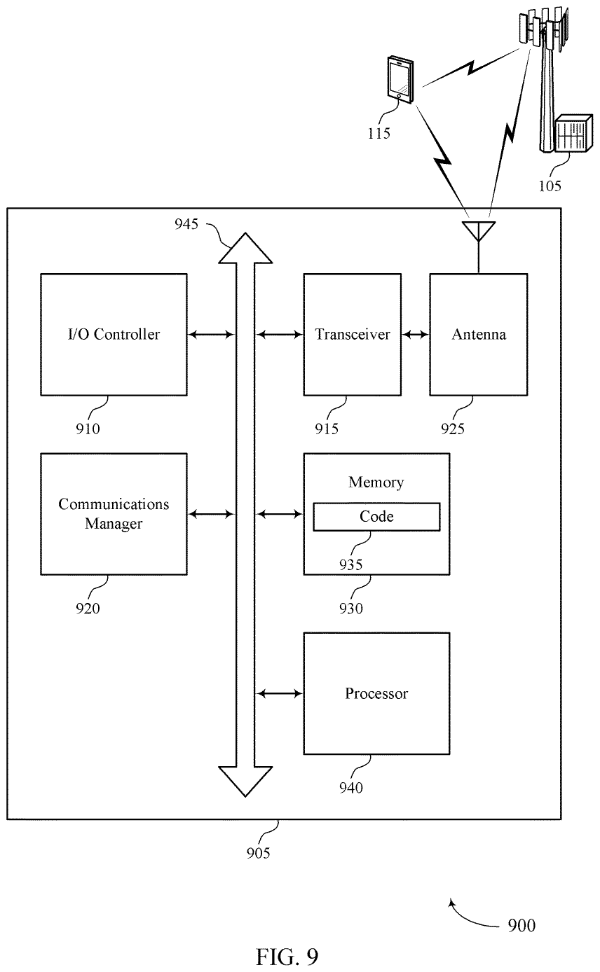

FIG. 9 illustrates a diagram of a system 900 including a device 905 that supports techniques for processing CSI in full duplex communications in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for processing CSI in full duplex communications). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for transmitting a first message indicating a CSI processing capability of the UE and a CSI timing capability of the UE. The communications manager 920 may be configured as or otherwise support a means for receiving a second message indicating a CSI configuration for one or more CSI reference signal resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications. The communications manager 920 may be configured as or otherwise support a means for receiving, via the one or more CSI reference signal resources of the full duplex slot, one or more CSI reference signals based on the CSI configuration. The communications manager 920 may be configured as or otherwise support a means for transmitting a CSI report based on the one or more CSI reference signals in accordance with the CSI processing capability and the CSI timing capability.

By including or configuring the communications manager 920 in accordance with examples as described herein, the device 905 may support techniques for more efficient utilization of communication resources. In particular, using the techniques described herein, the device 905 may support CSI measurement and reporting even in full duplex communications, which may support improved communications efficiency and reliability, reduced latency, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for processing CSI in full duplex communications as described herein, or the processor 940 and the memory 930 may be otherwise configured to perform or support such operations.

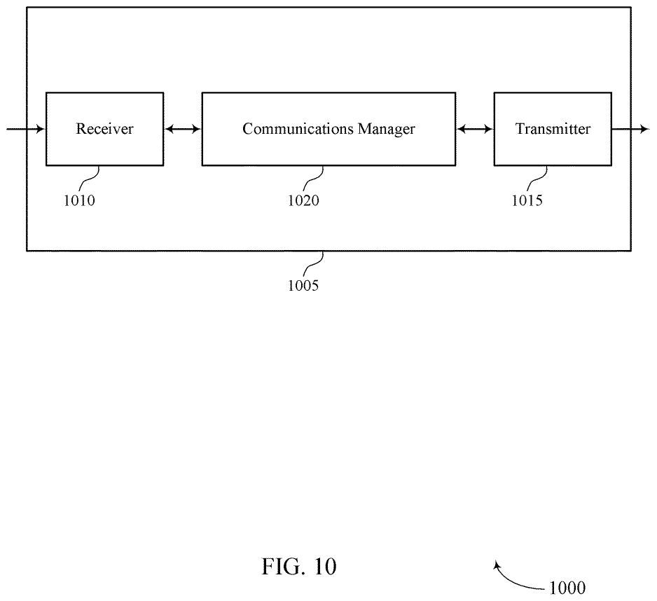

FIG. 10 illustrates a block diagram 1000 of a device 1005 that supports techniques for processing CSI in full duplex communications in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for processing CSI in full duplex communications as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for receiving, from a UE, a first message indicating a CSI processing capability of the UE and a CSI timing capability of the UE. The communications manager 1020 may be configured as or otherwise support a means for transmitting, to the UE, a second message indicating a CSI configuration for one or more CSI reference signal resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications. The communications manager 1020 may be configured as or otherwise support a means for transmitting, via the one or more CSI reference signal resources of the full duplex slot, one or more CSI reference signals based on the CSI configuration. The communications manager 1020 may be configured as or otherwise support a means for receiving a CSI report based on the one or more CSI reference signals in accordance with the CSI processing capability and the CSI timing capability.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for more efficient utilization of communication resources. In particular, using the techniques described herein, the device 1005 may perform CSI measurement and reporting when communicating according to full duplex communications. As a result, the device 1005 may be able to maximize the use of allocated resources or more efficiently utilize communication resources (e.g., by simultaneously transmitting and receiving using the communication resources).

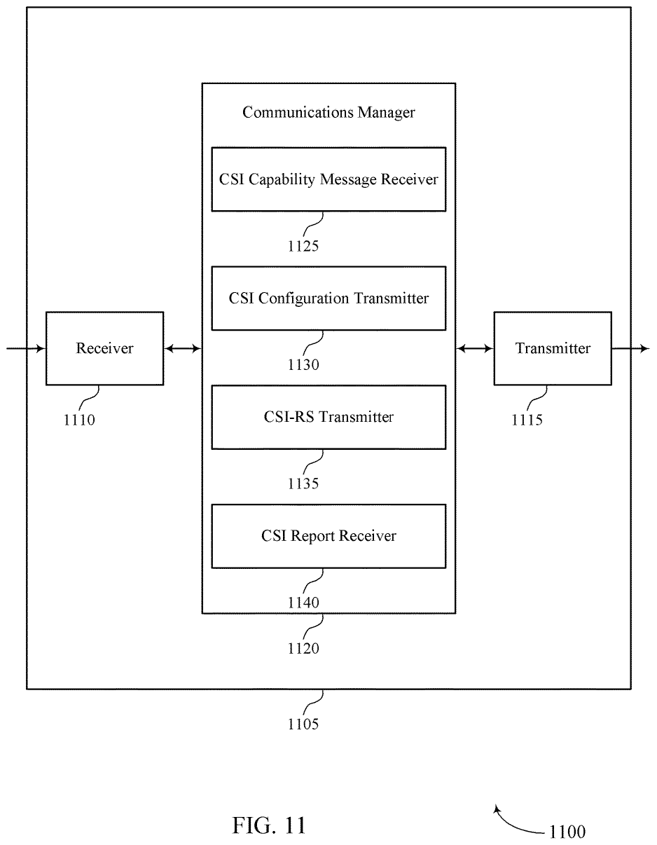

FIG. 11 illustrates a block diagram 1100 of a device 1105 that supports techniques for processing CSI in full duplex communications in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for processing CSI in full duplex communications as described herein. For example, the communications manager 1120 may include a CSI capability message receiver 1125, a CSI configuration transmitter 1130, a CSI-RS transmitter 1135, a CSI report receiver 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The CSI capability message receiver 1125 may be configured as or otherwise support a means for receiving, from a UE, a first message indicating a CSI processing capability of the UE and a CSI timing capability of the UE. The CSI configuration transmitter 1130 may be configured as or otherwise support a means for transmitting, to the UE, a second message indicating a CSI configuration for one or more CSI reference signal resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications. The CSI-RS transmitter 1135 may be configured as or otherwise support a means for transmitting, via the one or more CSI reference signal resources of the full duplex slot, one or more CSI reference signals based on the CSI configuration. The CSI report receiver 1140 may be configured as or otherwise support a means for receiving a CSI report based on the one or more CSI reference signals in accordance with the CSI processing capability and the CSI timing capability.

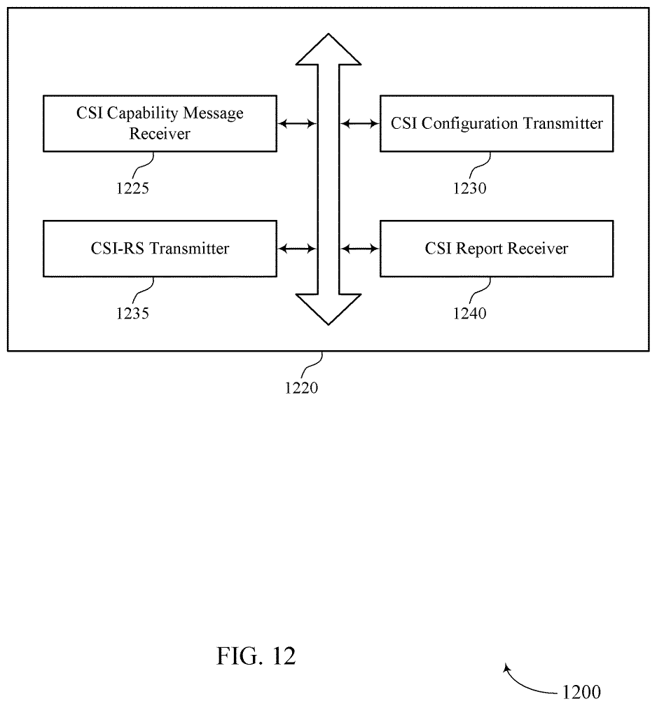

FIG. 12 illustrates a block diagram 1200 of a communications manager 1220 that supports techniques for processing CSI in full duplex communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for processing CSI in full duplex communications as described herein. For example, the communications manager 1220 may include a CSI capability message receiver 1225, a CSI configuration transmitter 1230, a CSI-RS transmitter 1235, a CSI report receiver 1240, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The CSI capability message receiver 1225 may be configured as or otherwise support a means for receiving, from a UE, a first message indicating a CSI processing capability of the UE and a CSI timing capability of the UE. The CSI configuration transmitter 1230 may be configured as or otherwise support a means for transmitting, to the UE, a second message indicating a CSI configuration for one or more CSI reference signal resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications. The CSI-RS transmitter 1235 may be configured as or otherwise support a means for transmitting, via the one or more CSI reference signal resources of the full duplex slot, one or more CSI reference signals based on the CSI configuration. The CSI report receiver 1240 may be configured as or otherwise support a means for receiving a CSI report based on the one or more CSI reference signals in accordance with the CSI processing capability and the CSI timing capability.

In some examples, to support transmitting the one or more CSI reference signals, the CSI-RS transmitter 1235 may be configured as or otherwise support a means for transmitting the one or more CSI reference signals via the first CSI reference signal resource and the second CSI reference signal resource.

In some examples, to support transmitting the one or more CSI reference signals, the CSI-RS transmitter 1235 may be configured as or otherwise support a means for transmitting the one or more CSI reference signals via the frequency resource.

In some examples, to support receiving the CSI report, the CSI report receiver 1240 may be configured as or otherwise support a means for receiving the CSI report including an indication that the UE jointly processed the one or more CSI reference signals using a quantity of CSI processing units of the UE in accordance with the CSI processing capability.

In some examples, to support receiving the CSI report, the CSI report receiver 1240 may be configured as or otherwise support a means for receiving the CSI report including an indication that the UE separately processed the one or more CSI reference signals using a quantity of CSI processing units of the UE in accordance with the CSI processing capability.

In some examples, the one or more CSI reference signal resources include a first CSI reference signal resource associated with a first downlink subband of the full duplex slot and a second CSI reference signal resource associated with a second downlink subband of the full duplex slot, and the CSI-RS transmitter 1235 may be configured as or otherwise support a means for configuring the first CSI reference signal resource in accordance with a first set of parameters. In some examples, the one or more CSI reference signal resources include a first CSI reference signal resource associated with a first downlink subband of the full duplex slot and a second CSI reference signal resource associated with a second downlink subband of the full duplex slot, and the CSI-RS transmitter 1235 may be configured as or otherwise support a means for configuring the second CSI reference signal resource in accordance with a second set of parameters, where the CSI report includes an indication that the UE jointly processed the one or more CSI reference signals based on the first set of parameters and the second set of parameters being the same.

In some examples, the one or more CSI reference signal resources include a first CSI reference signal resource associated with a first downlink subband of the full duplex slot and a second CSI reference signal resource associated with a second downlink subband of the full duplex slot, and the CSI-RS transmitter 1235 may be configured as or otherwise support a means for configuring the first CSI reference signal resource in accordance with a first set of parameters. In some examples, the one or more CSI reference signal resources include a first CSI reference signal resource associated with a first downlink subband of the full duplex slot and a second CSI reference signal resource associated with a second downlink subband of the full duplex slot, and the CSI-RS transmitter 1235 may be configured as or otherwise support a means for configuring the second CSI reference signal resource in accordance with a second set of parameters, where the CSI report includes an indication that the UE separately processed the one or more CSI reference signals based on the first set of parameters being different from the second set of parameters.

In some examples, to support receiving the CSI report, the CSI report receiver 1240 may be configured as or otherwise support a means for receiving the CSI report in accordance with a set of parameters associated with a latency classification for the CSI report based on the CSI timing capability.

In some examples, the latency classification is specific to subband full duplex slots.

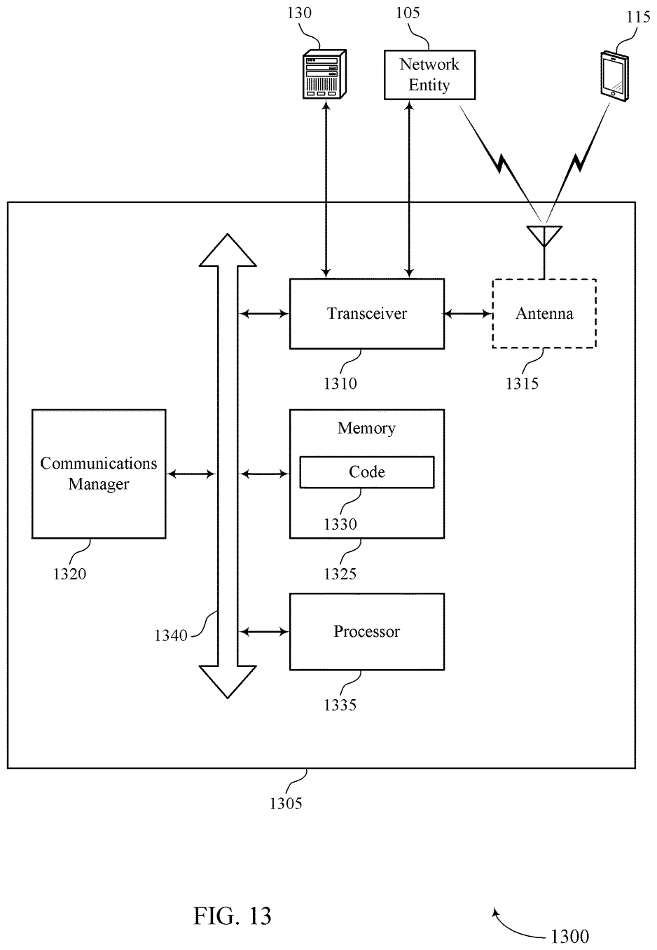

FIG. 13 illustrates a diagram of a system 1300 including a device 1305 that supports techniques for processing CSI in full duplex communications in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for processing CSI in full duplex communications). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for receiving, from a UE, a first message indicating a CSI processing capability of the UE and a CSI timing capability of the UE. The communications manager 1320 may be configured as or otherwise support a means for transmitting, to the UE, a second message indicating a CSI configuration for one or more CSI reference signal resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications. The communications manager 1320 may be configured as or otherwise support a means for transmitting, via the one or more CSI reference signal resources of the full duplex slot, one or more CSI reference signals based on the CSI configuration. The communications manager 1320 may be configured as or otherwise support a means for receiving a CSI report based on the one or more CSI reference signals in accordance with the CSI processing capability and the CSI timing capability.

By including or configuring the communications manager 1320 in accordance with examples as described herein, the device 1305 may support techniques for more efficient utilization of communication resources. In particular, using the techniques described herein, the device 1305 may support CSI measurement and reporting even in full duplex communications, which may support improved communications efficiency and reliability, reduced latency, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of techniques for processing CSI in full duplex communications as described herein, or the processor 1335 and the memory 1325 may be otherwise configured to perform or support such operations.

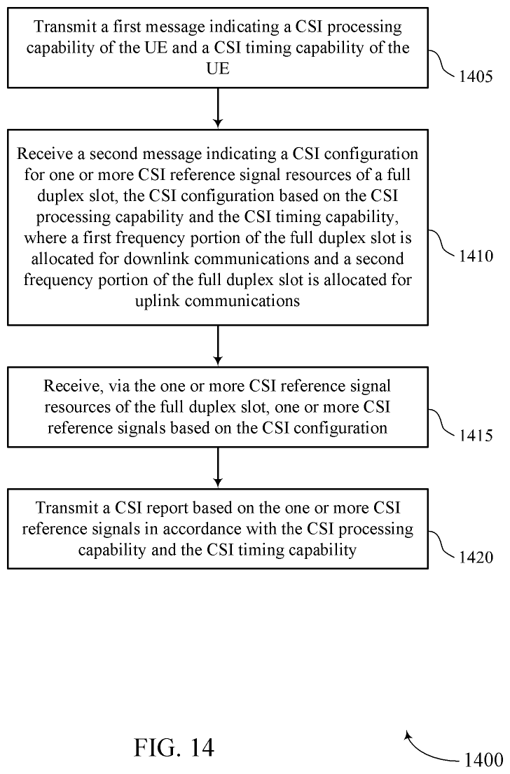

FIG. 14 illustrates a flowchart illustrating a method 1400 that supports techniques for processing CSI in full duplex communications in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting a first message indicating a CSI processing capability of the UE and a CSI timing capability of the UE. The operations of 1405 may be performed in accordance with examples as disclosed herein. In some examples, aspects of the operations of 1405 may be performed by a capability message transmitter 825 as described with reference to FIG. 8.

At 1410, the method may include receiving a second message indicating a CSI configuration for one or more CSI reference signal resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications. The operations of 1410 may be performed in accordance with examples as disclosed herein. In some examples, aspects of the operations of 1410 may be performed by a CSI configuration receiver 830 as described with reference to FIG. 8.

At 1415, the method may include receiving, via the one or more CSI reference signal resources of the full duplex slot, one or more CSI reference signals based on the CSI configuration. The operations of 1415 may be performed in accordance with examples as disclosed herein. In some examples, aspects of the operations of 1415 may be performed by a CSI-RS receiver 835 as described with reference to FIG. 8.

At 1420, the method may include transmitting a CSI report based on the one or more CSI reference signals in accordance with the CSI processing capability and the CSI timing capability. The operations of 1420 may be performed in accordance with examples as disclosed herein. In some examples, aspects of the operations of 1420 may be performed by a CSI report transmitter 840 as described with reference to FIG. 8.

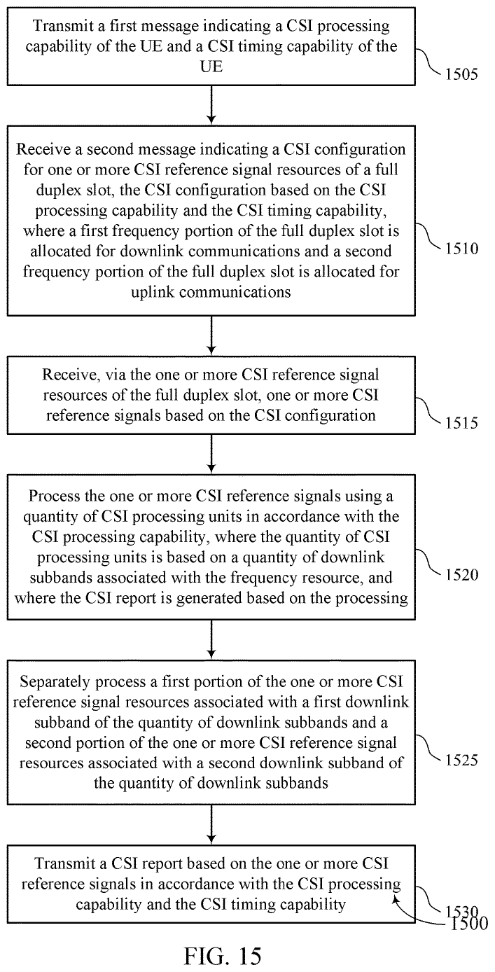

FIG. 15 illustrates a flowchart illustrating a method 1500 that supports techniques for processing CSI in full duplex communications in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting a first message indicating a CSI processing capability of the UE and a CSI timing capability of the UE. The operations of 1505 may be performed in accordance with examples as disclosed herein. In some examples, aspects of the operations of 1505 may be performed by a capability message transmitter 825 as described with reference to FIG. 8.

At 1510, the method may include receiving a second message indicating a CSI configuration for one or more CSI reference signal resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications. The operations of 1510 may be performed in accordance with examples as disclosed herein. In some examples, aspects of the operations of 1510 may be performed by a CSI configuration receiver 830 as described with reference to FIG. 8.

At 1515, the method may include receiving, via the one or more CSI reference signal resources of the full duplex slot, one or more CSI reference signals based on the CSI configuration. The operations of 1515 may be performed in accordance with examples as disclosed herein. In some examples, aspects of the operations of 1515 may be performed by a CSI-RS receiver 835 as described with reference to FIG. 8.

At 1520, the method may include processing the one or more CSI reference signals using a quantity of CSI processing units in accordance with the CSI processing capability, where the quantity of CSI processing units is based on a quantity of downlink subbands associated with the frequency resource, and where the CSI report is generated based on the processing. The operations of 1520 may be performed in accordance with examples as disclosed herein. In some examples, aspects of the operations of 1520 may be performed by a CSI processing component 845 as described with reference to FIG. 8.

At 1525, the method may include separately processing a first portion of the one or more CSI reference signal resources associated with a first downlink subband of the quantity of downlink subbands and a second portion of the one or more CSI reference signal resources associated with a second downlink subband of the quantity of downlink subbands. The operations of 1525 may be performed in accordance with examples as disclosed herein. In some examples, aspects of the operations of 1525 may be performed by a CSI processing component 845 as described with reference to FIG. 8.

At 1530, the method may include transmitting a CSI report based on the one or more CSI reference signals in accordance with the CSI processing capability and the CSI timing capability. The operations of 1530 may be performed in accordance with examples as disclosed herein. In some examples, aspects of the operations of 1530 may be performed by a CSI report transmitter 840 as described with reference to FIG. 8.

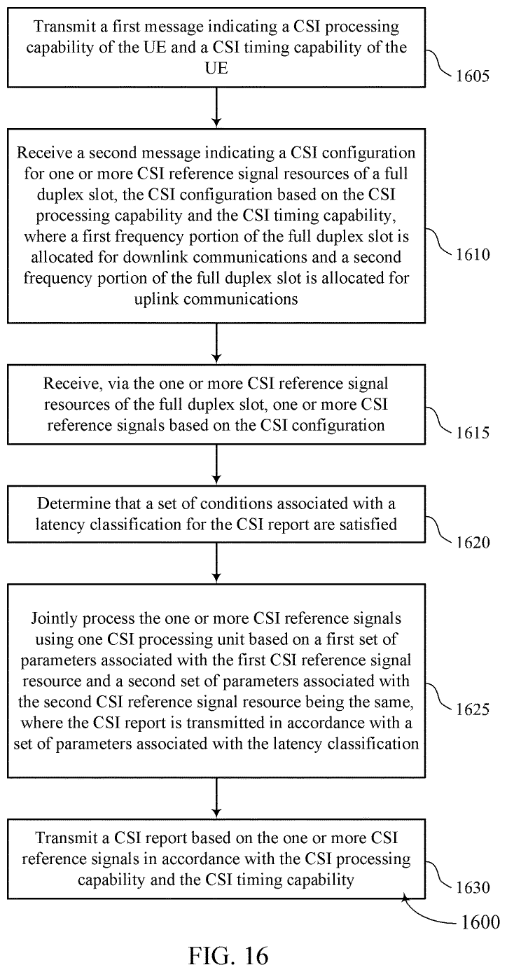

FIG. 16 illustrates a flowchart illustrating a method 1600 that supports techniques for processing CSI in full duplex communications in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include transmitting a first message indicating a CSI processing capability of the UE and a CSI timing capability of the UE. The operations of 1605 may be performed in accordance with examples as disclosed herein. In some examples, aspects of the operations of 1605 may be performed by a capability message transmitter 825 as described with reference to FIG. 8.

At 1610, the method may include receiving a second message indicating a CSI configuration for one or more CSI reference signal resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications. The operations of 1610 may be performed in accordance with examples as disclosed herein. In some examples, aspects of the operations of 1610 may be performed by a CSI configuration receiver 830 as described with reference to FIG. 8.

At 1615, the method may include receiving, via the one or more CSI reference signal resources of the full duplex slot, one or more CSI reference signals based on the CSI configuration. The operations of 1615 may be performed in accordance with examples as disclosed herein. In some examples, aspects of the operations of 1615 may be performed by a CSI-RS receiver 835 as described with reference to FIG. 8.

At 1620, the method may include determining that a set of conditions associated with a latency classification for the CSI report are satisfied. The operations of 1620 may be performed in accordance with examples as disclosed herein. In some examples, aspects of the operations of 1620 may be performed by a CSI timing component 850 as described with reference to FIG. 8.

At 1625, the method may include jointly processing the one or more CSI reference signals using one CSI processing unit based on a first set of parameters associated with the first CSI reference signal resource and a second set of parameters associated with the second CSI reference signal resource being the same, where the CSI report is transmitted in accordance with a set of parameters associated with the latency classification. The operations of 1625 may be performed in accordance with examples as disclosed herein. In some examples, aspects of the operations of 1625 may be performed by a CSI processing component 845 as described with reference to FIG. 8.

At 1630, the method may include transmitting a CSI report based on the one or more CSI reference signals in accordance with the CSI processing capability and the CSI timing capability. The operations of 1630 may be performed in accordance with examples as disclosed herein. In some examples, aspects of the operations of 1630 may be performed by a CSI report transmitter 840 as described with reference to FIG. 8.

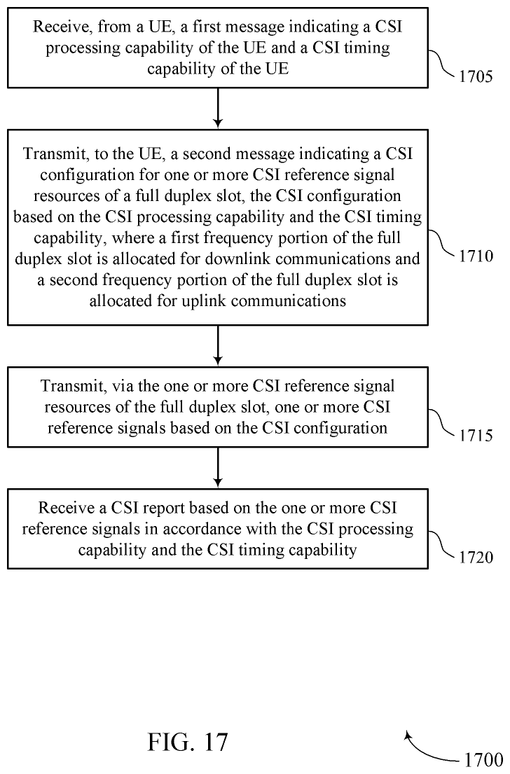

FIG. 17 illustrates a flowchart illustrating a method 1700 that supports techniques for processing CSI in full duplex communications in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include receiving, from a UE, a first message indicating a CSI processing capability of the UE and a CSI timing capability of the UE. The operations of 1705 may be performed in accordance with examples as disclosed herein. In some examples, aspects of the operations of 1705 may be performed by a CSI capability message receiver 1225 as described with reference to FIG. 12.

At 1710, the method may include transmitting, to the UE, a second message indicating a CSI configuration for one or more CSI reference signal resources of a full duplex slot, the CSI configuration based on the CSI processing capability and the CSI timing capability, where a first frequency portion of the full duplex slot is allocated for downlink communications and a second frequency portion of the full duplex slot is allocated for uplink communications. The operations of 1710 may be performed in accordance with examples as disclosed herein. In some examples, aspects of the operations of 1710 may be performed by a CSI configuration transmitter 1230 as described with reference to FIG. 12.

At 1715, the method may include transmitting, via the one or more CSI reference signal resources of the full duplex slot, one or more CSI reference signals based on the CSI configuration. The operations of 1715 may be performed in accordance with examples as disclosed herein. In some examples, aspects of the operations of 1715 may be performed by a CSI-RS transmitter 1235 as described with reference to FIG. 12.

At 1720, the method may include receiving a CSI report based on the one or more CSI reference signals in accordance with the CSI processing capability and the CSI timing capability. The operations of 1720 may be performed in accordance with examples as disclosed herein. In some examples, aspects of the operations of 1720 may be performed by a CSI report receiver 1240 as described with reference to FIG. 12.

The following provides an overview of aspects of the present disclosure:

Aspect 1: A method for wireless communications at a UE, comprising: transmitting a first message indicating a CSI processing capability of the UE and a CSI timing capability of the UE; receiving a second message indicating a CSI configuration for one or more CSI-RS resources of a full duplex slot, the CSI configuration based at least in part on the CSI processing capability and the CSI timing capability, wherein a first frequency portion of the full duplex slot is allocated for downlink communications and a second frequency portion of the full duplex slot is allocated for uplink communications; receiving, via the one or more CSI-RS resources of the full duplex slot, one or more CSI-RSs based at least in part on the CSI configuration; and transmitting a CSI report based at least in part on the one or more CSI-RSs in accordance with the CSI processing capability and the CSI timing capability.

Aspect 2: The method of aspect 1, further comprising: jointly processing the one or more CSI-RSs over two downlink subbands of the full duplex slot using a quantity of CSI processing units of the UE in accordance with the CSI processing capability, wherein the quantity of CSI processing units is equal to a quantity of the one or more CSI-RS resources, and wherein the CSI report is generated based at least in part on the processing.

Aspect 3: The method of any of aspects 1 through 2, wherein the one or more CSI-RS resources comprise a frequency resource that is noncontiguous in a frequency domain of the full duplex slot, the method further comprising: processing the one or more CSI-RSs using one CSI processing unit based at least in part on the frequency resource spanning a downlink subband of the full duplex slot, wherein the CSI report is generated based at least in part on the processing.

Aspect 4: The method of any of aspects 1 through 3, wherein the one or more CSI-RS resources comprise a frequency resource that is noncontiguous in a frequency domain of the full duplex slot, the method further comprising: processing the one or more CSI-RSs using a quantity of CSI processing units in accordance with the CSI processing capability, wherein the quantity of CSI processing units is based on a quantity of downlink subbands associated with the frequency resource, and wherein the CSI report is generated based at least in part on the processing.

Aspect 5: The method of aspect 4, wherein processing the one or more CSI-RSs comprises: separately processing a first portion of the one or more CSI-RS resources associated with a first downlink subband of the quantity of downlink subbands and a second portion of the one or more CSI-RS resources associated with a second downlink subband of the quantity of downlink subbands.

Aspect 6: The method of any of aspects 1 through 3, wherein the one or more CSI-RS resources comprise a frequency resource that is noncontiguous in a frequency domain of the full duplex slot, the method further comprising: processing the one or more CSI-RSs using one CSI processing unit based at least in part on a frequency allocation for the frequency resource in the full duplex slot being symmetric over two downlink subbands and based at least in part on a size of the frequency allocation satisfying a threshold, wherein the CSI report is generated based at least in part on the processing.

Aspect 7: The method of any of aspects 1 through 6, wherein the one or more CSI-RS resources comprise a frequency resource that is noncontiguous in a frequency domain of the full duplex slot, the method further comprising: processing the one or more CSI-RSs using two or more CSI processing units based at least in part on a frequency allocation for the frequency resource in the full duplex slot being asymmetric over two downlink subbands and based at least in part on a size of the frequency allocation failing to satisfy a threshold, wherein the CSI report is generated based at least in part on the processing.

Aspect 8: The method of any of aspects 1 through 2, wherein the one or more CSI-RS resources comprise a first CSI-RS resource associated with a first downlink subband of the full duplex slot and a second CSI-RS resource associated with a second downlink subband of the full duplex slot, the first CSI-RS resource and the second CSI-RS resource being contiguous in a frequency domain of the full duplex slot, the method further comprising: jointly processing the one or more CSI-RSs using a single CSI processing unit based on a set of parameters associated with the first CSI-RS resource and a set of parameters associated with the second CSI-RS resource being the same, wherein the CSI report is generated based at least in part on the processing.

Aspect 9: The method of any of aspects 1 through 8, wherein the one or more CSI-RS resources comprise a first CSI-RS resource associated with a first downlink subband of the full duplex slot and a second CSI-RS resource associated with a second downlink subband of the full duplex slot, the first CSI-RS resource and the second CSI-RS resource being contiguous in a frequency domain of the full duplex slot, the method further comprising: separately processing the one or more CSI-RSs using at least two CSI processing units based on one or more parameters associated with the first CSI-RS resource being different from one or more parameters associated with the second CSI-RS resource, wherein the CSI report is generated based at least in part on the processing.

Aspect 10: The method of any of aspects 1 through 9, wherein the one or more CSI-RS resources comprise a frequency resource that is noncontiguous in a frequency domain of the full duplex slot, the method further comprising: determining that a set of conditions associated with a latency classification for the CSI report are satisfied, wherein the latency classification corresponds to a threshold quantity of CSI processing units; and processing the one or more CSI-RSs using the threshold quantity of CSI processing units in accordance with the CSI processing capability based at least in part on the set of conditions being satisfied, wherein the CSI report is transmitted in accordance with a set of parameters associated with the latency classification based at least in part on the CSI timing capability.

Aspect 11: The method of any of aspects 1 through 10, wherein the one or more CSI-RS resources are associated with two or more downlink subbands of the full duplex slot, the method further comprising: determining that a set of conditions associated with a first latency classification for the CSI report are satisfied, wherein the first latency classification corresponds to a threshold quantity of CSI processing units; and processing the one or more CSI-RSs using a subset of the threshold quantity of CSI processing units in accordance with the CSI processing capability, wherein the CSI report is transmitted in accordance with a set of parameters associated with a second latency classification different from the first latency classification based at least in part on the one or more CSI-RS resources being allocated to the two or more downlink subbands.

Aspect 12: The method of any of aspects 1 through 11, wherein the one or more CSI-RS resources comprise a frequency resource that is noncontiguous in a frequency domain of the full duplex slot, the method further comprising: determining that a set of conditions associated with a latency classification for the CSI report are satisfied; and processing the one or more CSI-RSs using one CSI processing unit based at least in part on a size of a frequency domain resource allocation for the frequency resource in the full duplex slot satisfying a threshold, wherein the CSI report is transmitted in accordance with a set of parameters associated with the latency classification.

Aspect 13: The method of any of aspects 1 through 12, wherein the one or more CSI-RS resources comprise a first CSI-RS resource associated with a first downlink subband of the full duplex slot and a second CSI-RS resource associated with a second downlink subband of the full duplex slot, the first CSI-RS resource and the second CSI-RS resource being contiguous in a frequency domain of the full duplex slot, the method further comprising: determining that a set of conditions associated with a latency classification for the CSI report are satisfied; and jointly processing the one or more CSI-RSs using one CSI processing unit based at least in part on a first set of parameters associated with the first CSI-RS resource and a second set of parameters associated with the second CSI-RS resource being the same, wherein the CSI report is transmitted in accordance with a set of parameters associated with the latency classification.

Aspect 14: The method of any of aspects 1 through 13, further comprising: determining that a set of conditions associated with a latency classification for the CSI report are satisfied based at least in part on the CSI timing capability; and processing the one or more CSI-RSs using a quantity of CSI processing units in accordance with the CSI processing capability, wherein the CSI report is transmitted in accordance with a set of parameters associated with the latency classification.

Aspect 15: The method of aspect 14, wherein the latency classification is specific to SBFD slots.

Aspect 16: The method of any of aspects 1 through 15, further comprising: determining that a set of conditions associated with a first latency classification for the CSI report are satisfied based at least in part on the CSI timing capability; and processing the one or more CSI-RSs using a quantity of CSI processing units in accordance with the CSI processing capability, wherein the CSI report is transmitted in accordance with a set of parameters associated with a second latency classification different from the first latency classification based at least in part on the full duplex slot being a SBFD slot.

Aspect 17: The method of any of aspects 1 through 16, further comprising: processing the one or more CSI-RSs in accordance with a quantity of active CSI-RS resources, a quantity of active CSI-RS ports, or a combination thereof, based at least in part on the one or more CSI-RS resources comprising a frequency resource that is noncontiguous in a frequency domain portion of the full duplex slot, wherein the CSI report is generated based at least in part on the processing.

Aspect 18: The method of aspect 17, wherein the quantity of active CSI-RS resources is equal to one, and the quantity of active CSI-RS ports are counted once.

Aspect 19: The method of any of aspects 17 through 18, wherein the quantity of active CSI-RS resources is equal to two, and the quantity of active CSI-RS ports are counted twice.

Aspect 20: A method for wireless communications at a network entity, comprising: receiving, from a UE, a first message indicating a CSI processing capability of the UE and a CSI timing capability of the UE; transmitting, to the UE, a second message indicating a CSI configuration for one or more CSI-RS resources of a full duplex slot, the CSI configuration based at least in part on the CSI processing capability and the CSI timing capability, wherein a first frequency portion of the full duplex slot is allocated for downlink communications and a second frequency portion of the full duplex slot is allocated for uplink communications; transmitting, via the one or more CSI-RS resources of the full duplex slot, one or more CSI-RSs based at least in part on the CSI configuration; and receiving a CSI report based at least in part on the one or more CSI-RSs in accordance with the CSI processing capability and the CSI timing capability.

Aspect 21: The method of aspect 20, wherein the one or more CSI-RS resources comprise a first CSI-RS resource associated with a first downlink subband of the full duplex slot and a second CSI-RS resource associated with a second downlink subband of the full duplex slot, the first CSI-RS resource and the second CSI-RS resource being contiguous in a frequency domain of the full duplex slot, wherein transmitting the one or more CSI-RSs comprises: transmitting the one or more CSI-RSs via the first CSI-RS resource and the second CSI-RS resource.

Aspect 22: The method of any of aspects 20 through 21, wherein the one or more CSI-RS resources comprise a frequency resource that is noncontiguous in a frequency domain of the full duplex slot, and wherein transmitting the one or more CSI-RSs comprises: transmitting the one or more CSI-RSs via the frequency resource.

Aspect 23: The method of any of aspects 20 through 22, wherein receiving the CSI report comprises: receiving the CSI report including an indication that the UE jointly processed the one or more CSI-RSs using a quantity of CSI processing units of the UE in accordance with the CSI processing capability.

Aspect 24: The method of any of aspects 20 through 23, wherein receiving the CSI report comprises: receiving the CSI report including an indication that the UE separately processed the one or more CSI-RSs using a quantity of CSI processing units of the UE in accordance with the CSI processing capability.

Aspect 25: The method of any of aspects 20 through 24, wherein the one or more CSI-RS resources comprise a first CSI-RS resource associated with a first downlink subband of the full duplex slot and a second CSI-RS resource associated with a second downlink subband of the full duplex slot, the first CSI-RS resource and the second CSI-RS resource being contiguous in a frequency domain of the full duplex slot, the method further comprising: configuring the first CSI-RS resource in accordance with a first set of parameters; and configuring the second CSI-RS resource in accordance with a second set of parameters, wherein the CSI report includes an indication that the UE jointly processed the one or more CSI-RSs based at least in part on the first set of parameters and the second set of parameters being the same.

Aspect 26: The method of any of aspects 20 through 25, wherein the one or more CSI-RS resources comprise a first CSI-RS resource associated with a first downlink subband of the full duplex slot and a second CSI-RS resource associated with a second downlink subband of the full duplex slot, the first CSI-RS resource and the second CSI-RS resource being contiguous in a frequency domain of the full duplex slot, the method further comprising: configuring the first CSI-RS resource in accordance with a first set of parameters; and configuring the second CSI-RS resource in accordance with a second set of parameters, wherein the CSI report includes an indication that the UE separately processed the one or more CSI-RSs based at least in part on the first set of parameters being different from the second set of parameters.

Aspect 27: The method of any of aspects 20 through 26, wherein the one or more CSI-RS resources comprise a frequency resource that is noncontiguous in a frequency domain of the full duplex slot, and wherein receiving the CSI report comprises: receiving the CSI report in accordance with a set of parameters associated with a latency classification for the CSI report based at least in part on the CSI timing capability.

Aspect 28: The method of aspect 27, wherein the latency classification is specific to SBFD slots.

Aspect 29: An apparatus for wireless communications at a UE, comprising a processor; memory coupled with the processor; and instructions stored in the memory and executable by the processor to cause the apparatus to perform a method of any of aspects 1 through 19.

Aspect 30: An apparatus for wireless communications at a UE, comprising at least one means for performing a method of any of aspects 1 through 19.

Aspect 31: A non-transitory computer-readable medium storing code for wireless communications at a UE, the code comprising instructions executable by a processor to perform a method of any of aspects 1 through 19.

Aspect 32: An apparatus for wireless communications at a network entity, comprising a processor; memory coupled with the processor; and instructions stored in the memory and executable by the processor to cause the apparatus to perform a method of any of aspects 20 through 28.

Aspect 33: An apparatus for wireless communications at a network entity, comprising at least one means for performing a method of any of aspects 20 through 28.

Aspect 34: A non-transitory computer-readable medium storing code for wireless communications at a network entity, the code comprising instructions executable by a processor to perform a method of any of aspects 20 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
a memory; and
a processor coupled to the memory and configured to:
transmit a first message indicating a channel state information (CSI) processing capability of the UE and a CSI timing capability of the UE;
receive a second message indicating a CSI configuration for one or more CSI reference signal resources of a full duplex slot, the CSI configuration based at least in part on the CSI processing capability and the CSI timing capability, wherein a first frequency portion of the full duplex slot is allocated for downlink communications and a second frequency portion of the full duplex slot is allocated for uplink communications;
receive, via the one or more CSI reference signal resources of the full duplex slot, one or more CSI reference signals based at least in part on the CSI configuration; and
transmit a CSI report based at least in part on the one or more CSI reference signals in accordance with the CSI processing capability and the CSI timing capability.

2. The apparatus of claim 1, wherein the processor is further configured to:
jointly process the one or more CSI reference signals over two downlink subbands of the full duplex slot using a quantity of CSI processing units of the UE in accordance with the CSI processing capability, wherein the quantity of CSI processing units is equal to a quantity of the one or more CSI reference signal resources, and wherein the CSI report is generated based at least in part on the processing.

3. The apparatus of claim 1, wherein the one or more CSI reference signal resources comprise a frequency resource that is noncontiguous in a frequency domain of the full duplex slot, and the processor is further configured to:
process the one or more CSI reference signals using one CSI processing unit based at least in part on the frequency resource spanning a downlink subband of the full duplex slot, wherein the CSI report is generated based at least in part on the processing.

4. The apparatus of claim 1, wherein the one or more CSI reference signal resources comprise a frequency resource that is noncontiguous in a frequency domain of the full duplex slot, and the processor is further configured to:
process the one or more CSI reference signals using a quantity of CSI processing units in accordance with the CSI processing capability, wherein the quantity of CSI processing units is based on a quantity of downlink subbands associated with the frequency resource, and wherein the CSI report is generated based at least in part on the processing.

5. The apparatus of claim 4, wherein, to process the one or more CSI reference signals, the processor is configured to:
separately process a first portion of the one or more CSI reference signal resources associated with a first downlink subband of the quantity of downlink subbands and a second portion of the one or more CSI reference signal resources associated with a second downlink subband of the quantity of downlink subbands.

6. The apparatus of claim 1, wherein the one or more CSI reference signal resources comprise a frequency resource that is noncontiguous in a frequency domain of the full duplex slot, and the processor is further configured to:
process the one or more CSI reference signals using one CSI processing unit based at least in part on a frequency allocation for the frequency resource in the full duplex slot being symmetric over two downlink subbands and based at least in part on a size of the frequency allocation satisfying a threshold, wherein the CSI report is generated based at least in part on the processing.

7. The apparatus of claim 1, wherein the one or more CSI reference signal resources comprise a frequency resource that is noncontiguous in a frequency domain of the full duplex slot, and the processor is further configured to:
process the one or more CSI reference signals using two or more CSI processing units based at least in part on a frequency allocation for the frequency resource in the full duplex slot being asymmetric over two downlink subbands and based at least in part on a size of the frequency allocation failing to satisfy a threshold, wherein the CSI report is generated based at least in part on the processing.

8. The apparatus of claim 1, wherein the one or more CSI reference signal resources comprise a first CSI reference signal resource associated with a first downlink subband of the full duplex slot and a second CSI reference signal resource associated with a second downlink subband of the full duplex slot, and the processor is further configured to:
jointly process the one or more CSI reference signals using a single CSI processing unit based on a set of parameters associated with the first CSI reference signal resource and a set of parameters associated with the second CSI reference signal resource being the same, wherein the CSI report is generated based at least in part on the processing.

9. The apparatus of claim 1, wherein the one or more CSI reference signal resources comprise a first CSI reference signal resource associated with a first downlink subband of the full duplex slot and a second CSI reference signal resource associated with a second downlink subband of the full duplex slot, and the processor is further configured to:
separately process the one or more CSI reference signals using at least two CSI processing units based on one or more parameters associated with the first CSI reference signal resource being different from one or more parameters associated with the second CSI reference signal resource, wherein the CSI report is generated based at least in part on the processing.

10. The apparatus of claim 1, wherein the one or more CSI reference signal resources comprise a frequency resource that is noncontiguous in a frequency domain of the full duplex slot, and the processor is further configured to:
determine that a set of conditions associated with a latency classification for the CSI report are satisfied, wherein the latency classification corresponds to a threshold quantity of CSI processing units; and
process the one or more CSI reference signals using the threshold quantity of CSI processing units in accordance with the CSI processing capability based at least in part on the set of conditions being satisfied, wherein the CSI report is transmitted in accordance with a set of parameters associated with the latency classification based at least in part on the CSI timing capability.

11. The apparatus of claim 1, wherein the one or more CSI reference signal resources are associated with two or more downlink subbands of the full duplex slot, and the processor is further configured to:
determine that a set of conditions associated with a first latency classification for the CSI report are satisfied, wherein the first latency classification corresponds to a threshold quantity of CSI processing units; and
process the one or more CSI reference signals using a subset of the threshold quantity of CSI processing units in accordance with the CSI processing capability, wherein the CSI report is transmitted in accordance with a set of parameters associated with a second latency classification different from the first latency classification based at least in part on the one or more CSI reference signal resources being allocated to the two or more downlink subbands.

12. The apparatus of claim 1, wherein the one or more CSI reference signal resources comprise a frequency resource that is noncontiguous in a frequency domain of the full duplex slot, and the processor is further configured to:
determine that a set of conditions associated with a latency classification for the CSI report are satisfied; and
process the one or more CSI reference signals using one CSI processing unit based at least in part on a size of a frequency domain resource allocation for the frequency resource in the full duplex slot satisfying a threshold, wherein the CSI report is transmitted in accordance with a set of parameters associated with the latency classification.

13. The apparatus of claim 1, wherein the one or more CSI reference signal resources comprise a first CSI reference signal resource associated with a first downlink subband of the full duplex slot and a second CSI reference signal resource associated with a second downlink subband of the full duplex slot, and the processor is further configured to:
determine that a set of conditions associated with a latency classification for the CSI report are satisfied; and
jointly process the one or more CSI reference signals using one CSI processing unit based at least in part on a first set of parameters associated with the first CSI reference signal resource and a second set of parameters associated with the second CSI reference signal resource being the same, wherein the CSI report is transmitted in accordance with a set of parameters associated with the latency classification.

14. The apparatus of claim 1, wherein the processor is further configured to:
determine that a set of conditions associated with a latency classification for the CSI report are satisfied based at least in part on the CSI timing capability; and
process the one or more CSI reference signals using a quantity of CSI processing units in accordance with the CSI processing capability, wherein the CSI report is transmitted in accordance with a set of parameters associated with the latency classification.

15. (canceled)

16. The apparatus of claim 1, wherein the processor is further configured to:
determine that a set of conditions associated with a first latency classification for the CSI report are satisfied based at least in part on the CSI timing capability; and
process the one or more CSI reference signals using a quantity of CSI processing units in accordance with the CSI processing capability, wherein the CSI report is transmitted in accordance with a set of parameters associated with a second latency classification different from the first latency classification based at least in part on the full duplex slot being a subband full duplex slot.

17. The apparatus of claim 1, wherein the processor is further configured to:
process the one or more CSI reference signals in accordance with a quantity of active CSI reference signal resources, a quantity of active CSI reference signal ports, or a combination thereof, based at least in part on the one or more CSI reference signal resources comprising a frequency resource that is noncontiguous in a frequency domain portion of the full duplex slot, wherein the CSI report is generated based at least in part on the processing.

18. The apparatus of claim 17, wherein:
the quantity of active CSI reference signal resources is equal to one, and
the quantity of active CSI reference signal ports are counted once.

19. The apparatus of claim 17, wherein:
the quantity of active CSI reference signal resources is equal to two, and
the quantity of active CSI reference signal ports are counted twice.

20-28. (canceled)

21. A method for wireless communications at a user equipment (UE), comprising:
transmitting a first message indicating a channel state information (CSI) processing capability of the UE and a CSI timing capability of the UE;
receiving a second message indicating a CSI configuration for one or more CSI reference signal resources of a full duplex slot, the CSI configuration based at least in part on the CSI processing capability and the CSI timing capability, wherein a first frequency portion of the full duplex slot is allocated for downlink communications and a second frequency portion of the full duplex slot is allocated for uplink communications;
receiving, via the one or more CSI reference signal resources of the full duplex slot, one or more CSI reference signals based at least in part on the CSI configuration; and
transmitting a CSI report based at least in part on the one or more CSI reference signals in accordance with the CSI processing capability and the CSI timing capability.

22. A method for wireless communications at a network entity, comprising:
receiving, from a user equipment (UE), a first message indicating a channel state information (CSI) processing capability of the UE and a CSI timing capability of the UE;
transmitting, to the UE, a second message indicating a CSI configuration for one or more CSI reference signal resources of a full duplex slot, the CSI configuration based at least in part on the CSI processing capability and the CSI timing capability, wherein a first frequency portion of the full duplex slot is allocated for downlink communications and a second frequency portion of the full duplex slot is allocated for uplink communications;
transmitting, via the one or more CSI reference signal resources of the full duplex slot, one or more CSI reference signals based at least in part on the CSI configuration; and
receiving a CSI report based at least in part on the one or more CSI reference signals in accordance with the CSI processing capability and the CSI timing capability.
